(19) United States
(12) Patent Application Publication
(10) Pub. No.: US 2023/0166549 A1
(43) Pub. Date: Jun. 1, 2023

(54) METHOD FOR ELECTRIC FIELD ASSISTED, NON-CONTACT PRINTING AND PRINTED SENSORS

(71) Applicants: UNIVERSITY OF SOUTH FLORIDA, Tampa, FL (US); REGENTS OF THE UNIVERSITY OF CALIFORNIA, Oakland, CA (US)

(72) Inventors: Ying Zhong, Lutz, FL (US); Long Wang, San Diego, CA (US); Rui Kou, La Jolla, CA (US)

(21) Appl. No.: 17/922,055

(22) PCT Filed: May 3, 2021
(86) PCT No.: PCT/US2021/030446

§ 371 Date: Oct. 28, 2022

Related U.S. Application Data
(60) Provisional application No. 63/019,121, filed on May 1, 2020.
(60) Provisional application No. 63/019,028, filed on May 1, 2020.

(51) Int. Cl. B41M 1/30; G01N 27/12

(52) U.S. Cl. CPC B41M 1/305; G01N 27/122

(57) ABSTRACT

The invention relates to a non-contact printing method and system as well as to a printed sensor. The method includes the steps of disposing a substrate (130) between a discharge electrode (110) and a printing material (140) such that the substrate (130) is spaced apart from the printing material (140); and activating the discharge electrode (110) to generate an electric field between the substrate (130) and the printing material (140), wherein the printing material (140) moves onto a surface (132) of the substrate (130) when the electric field attracts the printing material (140) to the surface (132) of the substrate (130). A corresponding printing system and printed sensor are also provided.

### CLAIM OF PRIORITY

This application claims priority under 35 USC § 119(e) to U.S. Patent Application Ser. No. 63/019,028, filed on May 1, 2020, and U.S. Patent Application Ser. No. 63/019,121 filed May 1, 2020, the entire contents of both of which are hereby incorporated by reference.

### TECHNICAL FIELD

This document relates to non-contact methods of printing and printed sensors, for example, methods of real-time, non-contact printing of materials onto surfaces using an electric field and sensors manufactured using the methods.

### BACKGROUND

Traditional printing methods rely on inks and complex combinations of materials and binders. Printing these liquid mixtures on thin films, fabrics, or other substrates can be time-intensive and requires time for the printed materials to dry, leading to increased costs and production times. To achieve high throughput in printing systems, substrates can be used in roll-to-roll carriers, a method by which substrates can be passed continuously through a printing system to lower the time of production. However, systems which utilize a roll-to-roll method must still be operated at low speeds to cover the long drying time for the printed materials. The drying time in a traditional printing process is generally the largest bottleneck in manufacturing efficiency and cost.

Currently, screen printing is the most commonly used scalable printing technology for fabricating printed flexible electronics. Screen printing as well as other non-contact methods such as inkjet printing require liquid inks, require long drying times. Screen printing also has other disadvantages, such as being hard to clean, wasting materials, and deteriorating masks.

### SUMMARY

This document relates to non-contact methods of printing and printed sensors, for example, methods of real-time, non-contact printing of materials onto surfaces using an electric field and sensors manufactured using the methods. The systems and methods provided herein can provide both a rapid, efficient, and controllable non-contact printing method by creating an electrically assisted environment. By generating an electric field to charge a substrate and inducing a material onto the charged substrate, rapid non-contact printing can be achieved. In particular, the embodiments described herein can use the strong generated electric fields of a plasma discharge device to charge a non-conductive substrate thereby generating an electric field between the substrate and a material. The generated electric field can then induce materials onto the substrate to be printed. As polymer substrates can be easily configured for a roll-to-roll printing method and binder-less powdered materials do not require drying times, the production of printed materials on a roll-to-roll printing system can achieve both low cost and high volume. While binders may optionally be used, the methods described herein do not require binders or liquid inks and therefore higher material densities can be achieved when printed onto the substrate.

The non-contact printing systems and methods provided herein can advantageously print complex combinations of dry materials while using efficient production methods (e.g., roll-to-roll methods). Furthermore, the methods provided herein can even be applied to rapidly print materials on thin films, fabrics, and other substrates. For example, in some embodiments, the systems and methods provided herein can apply a roll-to-roll production method to achieve high throughput. Further, due to the lack of non-conductive binders in the non-contact printing process when conductive powders are used, less material is required to achieve similar conductivity to traditional thin film printing methods using conductive inks.

In a first aspect, the disclosure includes a method of printing, including disposing a substrate between a discharge electrode and a printing material, the substrate being spaced apart from the printing material; and activating the discharge electrode to generate an electric field between the substrate and the printing material, wherein the printing material moves onto a surface of the substrate when the electric field attracts the printing material to the surface of the substrate.

In some embodiments, generating the electric field can include applying a corona treatment to the substrate. The generating the electric field can include applying a voltage of about 5 kV to about 100 kV to the discharge electrode. The substrate can include a film, textile, a 3D printed object, an injection molded object, an assembled object, or a welded object. The substrate can include one or more polymers selected from the group consisting of polyurethane, a nylon, polyester, polystyrene, polyethylene terephthalate (PET), polymethyl methacrylate (PMMA), polyethylene (PE), polystyrene (PS), and silicone. The substrate can include a dielectric material, or a dielectric-coated material. The printing material can include wires, tubes, particles, powders, or combinations thereof. The printing material can include particles having a mean particle size that is selected from a group consisting of less than 2 mm, less than 500 μm, less than 300 μm, and less than 50 μm.

In a second aspect, the disclosure includes a system for non-contact printing, the system including a substrate, a discharge electrode coupled to a power source, the discharge electrode configured to apply an electrical discharge to the substrate located in a zone; a source including a printing material, the source positioned adjacent to the substrate; and a conveyer configured for transporting the substrate; wherein, when the substrate is placed in the zone, the system is configured to generate an electric field between the substrate and the printing material such that the printing material moves from the source to a portion of the substrate to from a printed substrate; and wherein the system continuously transports the printed substrate away from the zone while placing a new substrate in the zone.

In some embodiments, the substrate can be in the form of sheets or a roll. The conveyer can include one or more rollers for transporting the substrate. The discharge electrode can include multiple discharge electrodes. The source can be configured to provide a renewed supply of printing material.

In a third aspect, the disclosure includes a sensor, including a substrate; one or more electrodes electrically coupled to the substrate; and a plurality of conductive particles disposed on a surface of the substrate, wherein the sensor is substantially free of a binder.

In some embodiments, the substrate contains one of less than 1 wt. % of a binder, less than 5 wt. % of a binder, less than 1 wt. % of a binder, or less than 0.1 wt. % of a binder. The conductive particles comprise graphene. The sensor can be configured to monitor one or more physiological parameters selected from the group consisting of skin conductivity, glucose, respiration, oculogyration, oxygen saturation, temperature, heart rate, pulsation, electrical activity, pH, chemical presence, neurological activity, eye blinking, facial expressions, vocal vibrations, mouth movements, swallowing, elbow movements, arm movement, hand pressure, or foot pressure. The sensor can be configured to detect a pressure applied on the substrate. The sensor can be configured to detect, or differentiate sound waves.

In some embodiments, a protective layer can be disposed on the surface of the substrate, wherein the protective layer can include polyurethane, a nylon, polyester, polystyrene, polyethylene terephthalate (PET), polymethyl methacrylate (PMMA), polyethylene (PE), polystyrene (PS), and The details of one or more embodiments of the invention are set forth in the accompanying drawings and the description below. Other features, objects, and advantages of the invention will be apparent from the description and drawings, and from the claims.

Unless otherwise defined, all technical and scientific terms used herein have the same meaning as commonly understood by one of ordinary skill in the art to which this invention pertains. Although methods and materials similar or equivalent to those described herein can be used to practice the invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

### DESCRIPTION OF DRAWINGS

FIG. 1 is a schematic diagram of an exemplary non-contact printing system.

FIG. 2A is a schematic diagram of the non-contact printing system producing an effect of accumulated charges on a thin film in drawing materials to a surface of the polymer film.

FIG. 2B is a schematic diagram of the non-contact printing system after drawing and adhering material to the film.

FIG. 2C is a schematic diagram of the printed material on a film substrate.

FIG. 3A is a scanning electron microscope image showing particle adsorption to a textile substrate.

FIG. 3B and FIG. 3C are scanning electron microscope images showing particle adsorption to substrates at various electrode voltages.

FIG. 3D is a graph showing number of particles versus particle size at various electrode voltages.

FIG. 3E is a graph showing percentage of size versus average particle size at various electrode voltages.

FIG. 4A and FIG. 4B are images of exemplary masked printed material.

FIG. 5 is a schematic illustration of an exemplary roll-to-roll substrate system used for continuous plasma discharge printing.

FIG. 6 is a schematic illustration of an exemplary roll-to-roll substrate system used for continuous plasma discharge printing.

FIG. 7 is a series of six simulated images of the dynamic material transfer process.

FIG. 8A through 8I are line charts showing calculated average accelerations, average velocities, and average displacements for simulated particles.

FIG. 9A through FIG. 9D are exemplary sensors after masking and processing through the material printing system.

FIG. 10A is a schematic diagram of a uniaxial strain system for testing a sensor.

FIG. 10B is a graph comparing the change in resistivity of a sensor with uniaxial strain.

FIG. 10C is a graph comparing the change in resistivity of a sensor with time when uniaxial strain is cyclically applied.

FIG. 10D through FIG. 10F are scanning electron microscope magnified images of an exemplary strain sensor when 0%, 5%, and 10% uniaxial strain are applied, respectively.

FIG. 11A through FIG. 11H are optical microscope of an exemplary sensor when 5%, 10%, 15%, and 20% uniaxial strain are applied, respectively, with digital image correlation overlays.

FIG. 11I is an optical microscope image of an exemplary sensor.

FIG. 11J is an optical microscope image of an exemplary sensor processed to enhance contrast.

FIG. 11K is a simulated image of an exemplary sensor depicting the simulated geometric finite elements. FIG. 11L is a simulated image of an exemplary sensor depicting the simulated electric potential field distribution.

FIG. 11M through FIG. 11P are simulated images of an exemplary sensors depicting simulated electric potential field distributions when 5%, 10%, 15%, and 20% uniaxial strains are applied, respectively.

FIG. 12A through FIG. 12E are images of an exemplary sensor affixed to a finger of a user under various bending angles.

FIG. 12F is a graph comparing the change in resistivity of an exemplary sensor affixed to a finger with time when the finger applies multiaxial strain through bending.

FIG. 12G is a graph comparing the change in resistivity of an exemplary sensor affixed to a finger with bending angle.

FIG. 13A is a schematic diagram of an exemplary sensor in a mechanical pressure system.

FIG. 13B is a graph comparing the change in resistivity of an exemplary sensor with cycle count when a mechanical pressure is cyclically applied.

FIG. 13C through FIG. 13F are images depicting an exemplary sensor affixed to the skin of a subject with pressure being applied in various area.

FIG. 13G through FIG. 13J are electrical impedance tomography images of changes in resistivity of an exemplary sensor affixed to the skin of a subject when pressure is applied in various areas.

FIG. 14A is a schematic diagram of an exemplary sensor in a pressurized air system.

FIG. 14B is a graph comparing change in resistivity of an exemplary sensor with time when a pressurized air is cyclically applied.

FIG. 14C is a graph comparing change in resistivity of an exemplary sensor with pressure when pressurized air is applied.

FIG. 15A is a schematic diagram of a flexible embedded sensor implanted in the ear canal of a user when an audio signal is transmitted through a speaker.

FIG. 15B is a schematic diagram of an exemplary sensor affixed to a speaker to apply a transmitted audio signal.

FIG. 15C and FIG. 15D are graphs comparing power density with frequency when an audio signal is applied to a flexible material sensor through a speaker.

FIG. 16A is a first image depicting an exemplary flexible material sensor created with a masked non-contact printing system using four distinct thermochromic powders.

FIG. 16B is a second image depicting an exemplary flexible material sensor created with a masked non-contact printing system using four distinct thermochromic powders.

FIG. 16C is a graph comparing optical intensity with time when a changing temperature is applied to an exemplary flexible material sensor created with four distinct thermochromic powders.

FIG. 16D through 16G are graphs comparing optical intensity with time when a changing temperature is applied to flexible material sensors created with four distinct thermochromic powders.

FIG. 17A and 17B are scanning electron microscope images of material networks using an ink and binder printing method.

### DETAILED DESCRIPTION

This document relates to non-contact methods of printing and printed sensors, for example, methods of real-time, non-contact printing of materials onto surfaces using an electric field and sensors manufactured using the methods. Embodiments provided herein will be further described in the following examples, which do not limit the scope of the invention described in the claims.

I. Methods of Printing

Described herein are non-contact methods of printing, for example, methods of real-time, non-contact printing of materials onto surfaces using an electric field.

0 shows an exemplary non-contact printing system 100. The system includes a plasma discharge apparatus 105 that uses a discharge electrode 110 operated at high voltage. In some embodiments, the conductive electrode may be operated at a high voltage that ranges from about 5k to about 100 kV (e.g., about 5 kV to about 20 kV, about 5 kV to about 40 kV, about 5 kV to about 60 kV, about 5 kV to about 80 kV, about 5 kV to about 100 kV, 15 kV to about 30 kV, about 20 kV to about 100 kV, about 10 kV to about 50 kV, about 40 kV to about 100 kV, about 60 kV to about 100 kV, or about 80 kV to about 100 kV).

The applied voltage induces an electric field at the tip 112 of the conductive electrode 110 sufficient to ionize gas molecules in proximity to the tip 112, thus creating an electric field zone. In this zone, ions can accelerate across the electric field zone in a plasma discharge 120 and extend to a non-conductive substrate 130 of the non-contact printing system 100. The substrate 130 can include a variety of materials. For instance, non-limiting examples of the substrate 130 may include non-conductive materials such as ceramic, polymer, glass, dielectric materials, non-conductive metals, wood, paper, fabric, or combinations thereof. In some embodiments, the substrate 130 can be a two dimensional substrate (e.g., a thin film). In some embodiments, the substrate 130 can be a three dimensional substrate (e.g., a fibrous matrix, a textile, a 3D printed object, or an injection molded object, an assembled object, a welded object, or foam). In some embodiments, the textile three dimensional substrate can be an arrangement of fibers (e.g., synthetic fibers, elastane fibers (spandex), natural fibers, cotton fibers, polyester fibers, polyethylene fibers, nylon fibers, or combinations thereof). For example, a polymer substrate 130 can include a two- or three dimensional substrate 130 made from any one or more example of thermoset, thermoplastic, rubber, or natural polymers. Non-limiting examples of these polymers can include polyurethane, nylon, polyester, polystyrene, polyethylene terephthalate (PET), polymethyl methacrylate (PMMA), polyethylene (PE), polystyrene (PS), and silicone. The substrate 130 can be transparent, semi-transparent, or opaque. The substrate 130 can be gas (e.g., air) permeable, or gas impermeable. The substrate 130 can be fully or partially waterproof.

In general, the substrate 130 can include a binding element (e.g., an adhesive) to adhere the particles to the substrate 130. In some embodiments, the substrate can include less than 1 wt. % of a binder (e.g., less than 0.5 wt. % of a binder, less than 0.1 wt. % of a binder, or less than 0.01 wt. % of a binder.) In some embodiments, the substrate can include more than 1 wt. % of a binder (e.g., more than 5 wt. % of a binder, more than 10 wt. % of a binder, more than 20 wt. % of a binder, or more than 50 wt. % of a binder).

In general, the substrate 130 can have mechanical properties similar to human skin. For example, the substrate 130 can have similar flexibility to human skin, similar stress/strain characteristics, and be able to conform to a skin surface of a user.

A gas can be used in the non-contact printing system 100 to produce the plasma discharge. The gas can be a heterogeneous mixture, or a homogenous gas. Non-limiting examples of the gas can include air, argon, oxygen, nitrogen, or combinations thereof. Further, the gas used in the plasma discharge system 100 can be applied at, above, or below atmospheric pressure.

In general, the discharge electrode 110 can be any diameter or length useable within the plasma discharge apparatus 105 that maintains a distance to the substrate 130 suitable for plasma discharge 120. Non-limiting examples of the distance between the plasma discharge apparatus 105 and the substrate 130 can be from 1 cm to 10 cm (e.g., 1 to 10 cm, 3 to 10 cm, 5 to 10 cm, 7 to 10 cm, 9 to 10 cm, 2 to 8 cm, 4 to 6 cm, 4 to 8 cm, 6 to 8 cm). In general, the discharge electrode 110 can be made of a conductive material. Non-limiting examples of materials from which the discharge electrode 110 can be made include metallic composites, carbon, a semiconductor, steel, tungsten, titanium, cobalt, or combinations thereof. In some embodiments, the discharge electrode can also be a charged object.

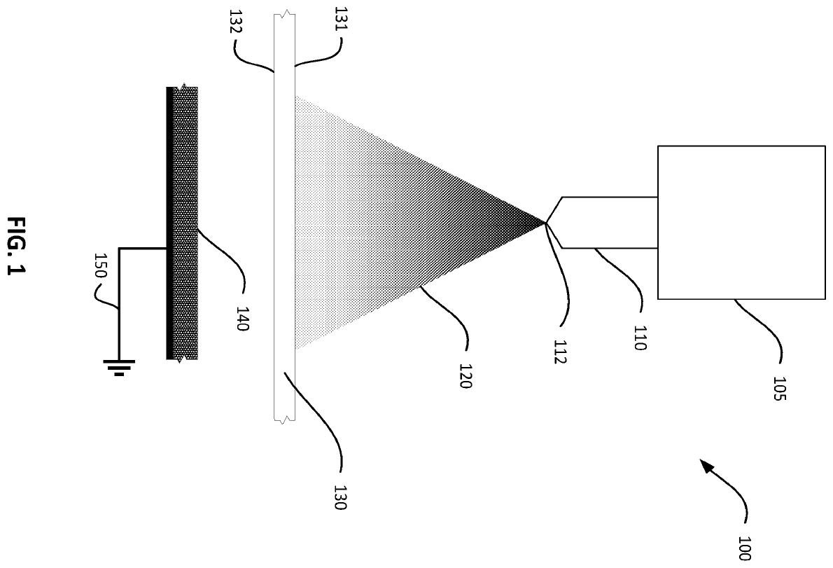

The exemplary plasma discharge apparatus 105 depicts a discharge electrode 110 in the shape of a needle with a sharp point. In some embodiments, other types of electrode shapes can be used. For example, the discharge electrode 110 shape can include, but is not limited to, a wire, a blade, a surface with an edge, a wedge point, or any combination thereof. Although the exemplary plasma discharge apparatus 105 of FIG. 1 depicts the use of a single discharge electrode 110, in some embodiments, one or more discharge electrodes 110 in an array can be used (e.g., two or more, three or more, four or more).

In system 100, the plasma discharge apparatus 105 is placed above a first surface 131 of the substrate 130 to be treated. Without being bound by theory, it is believed that the effect of the plasma discharge 120 on the surface imparts a charge to the first surface 131 of the substrate 130 exposed to the plasma discharge 120. The accumulation of charge on the first surface 131 can induce a secondary electric field in the region between the second surface 132 and the material 140. Once the secondary electric field reaches a sufficient strength, a portion of the material 140 will be inducted and attracted towards the second surface 132 facing the material 140. In general, the thin film can be a flat non-conductive polymer film or textile, or other three dimensional structure of the same material.

Positioned adjacent to the second surface 132 of the substrate 130 is a source of material 140 spaced apart from the second surface 132 directed away from the plasma discharge 120. The source of material 140 can be spaced apart a distance that allows a portion of the material 140 to be drawn to the second surface 132 by the electric field induced by the plasma discharge 120. Non-limiting examples of the distance between the substrate 130 and material 140 can include about 1 cm to about 10 cm (e.g., about 1 cm to about 10 cm, about 1 cm to about 8 cm, about 2 cm to about 6 cm, about 1 cm to about 10 cm, about 2 cm to about 8 cm, or about 4 cm to about 10 cm).

The printing material 140 can be comprised of any material that is responsive to a generated electric field. In some embodiments, the printing material is a micro- or nano-sized material. The printing material can include materials of various shapes. Examples of suitable printing materials can include, but are not limited to, graphene, quantum dots, electroluminescent materials, piezoelectric materials, carbon nanotubes, silver powder, iron powder, silver nanowires, thermochromic powders, or combinations thereof. In some embodiments, the material 140 can include at least one conductive or semi-conductive polymer, ceramic, metal, or combinations thereof. Exemplary materials includes metallic powders, metallic nanoparticles, metallic microparticles, carbon nanoparticles, carbon microparticles, nanorods, nanowires, microrods, microwires, metallic microsheets, metallic nanosheets, carbon nanosheets, carbon microsheets, PEDOT: PSS particles, indium tin oxide particles, polymer particles, ceramic particles, or a combination thereof.

In some embodiments, the material 140 can be charged with an opposite charge to the discharge electrode 110. For example, the material 140 can be contacted by a charged wire to induce a charge in the material 140. For example, if a positive plasma discharge 120 is used, a positive charge can accumulate on the first surface 131 of the substrate, and positive charges on the second surface. If the material 140 is charged with a charge opposite to the discharge electrode, this can increase the electric attraction between the material 140 and the second surface 132 of the substrate 130 thereby increasing induction of the material 140 to the second surface 132.

In some embodiments, the material 140 can have a mean maximum particle size of less than 1 mm (e.g., less than 1 mm, less than 700 μm, less than 500 μm, less than 300 μm, less than 50 μm). Further non-limiting examples of material 140 can have a mean particle size in the range of about 1 μm to about 2 mm (e.g., about 1 μm to about 2 mm, about 100 μm to about 900 μm, about 200 μm to about 700 μm, about 400 μm to about 600 μm, about 1 μm to about 50 μm, about 10 μm to about 40 μm, about 20 μm to about 30 μm). In some embodiments, the material 140 can have a mean maximum particle size of 325 mesh (e.g., 44 μm).

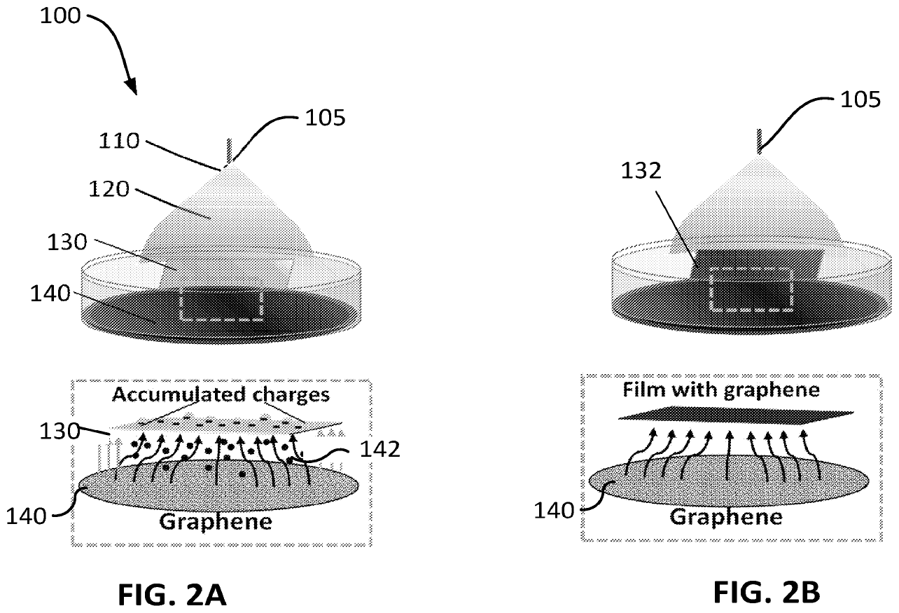

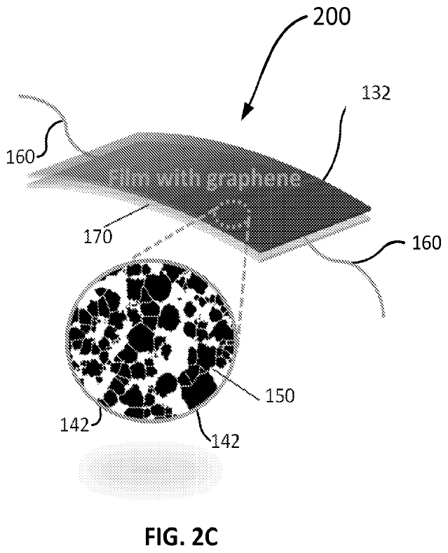

FIGS. 2A-2C depict a process of printing using a non-contact material printing system 200. The system 200 includes a plasma discharge apparatus 105 that is used for printing on a thin film 210 as the substrate 130. The thin film 210 is shown positioned a distance above a material 140. The thin film 210 can be a two-dimensional substrate having a length and width substantially greater than a depth.

As shown in a magnified image in FIG. 2A, the process can begin by exposing a thin film 210 to a plasma discharge 120 generated by a plasma discharge apparatus 105. A charge can be accumulated on the first surface of the thin film and generate a secondary electric field in the region between the second surface of the thin film and the material 140. The secondary electric field can draw up individual particles 142 of the material 140 to be adsorbed onto the second surface of the thin film. In general, the thin film can be a flat non-conductive polymer film or textile, or other three dimensional structure of the same material.

In some embodiments, the thin film 210 may coated on one or more surfaces with an adhesive. For embodiments using an adhesive-coated thin film 210, the adhesive-coated surface can be oriented toward the material 140 during processing with the non-contact printing system 100 and can strengthen the adsorption of the material 140 to the thin film 210. In general, the adhesive can be any polymer adhesive but non-limiting examples can include acrylic, polyurethane, polydimethylsiloxane (PDMS), polyvinyl acetate, cyanoacrylate, polyols, polyester, or any combination thereof.

In some embodiments, the material 140 can include a dry particle binder. After induction of the material 140 and the dry particle binder to the substrate 130, the substrate 130 can be heated to a temperature sufficient to melt the dry particle binder and strengthen the bond of the material 140 to the substrate 130. In general, the dry particle binder can be any polymer but non-limiting examples can include acrylic, polyurethane, polydimethylsiloxane (PDMS), polyvinyl acetate, cyanoacrylate, polyols, polyester, or any combination thereof. In some embodiments, the dry particle binder can be inducted onto the substrate 130 before the material 140. In some embodiments, the dry particle binder can be inducted onto the substrate 130 using a mask to form a pattern.

FIG. 2B shows the thin film 210 after processing with the non-contact printing system 100 and has formed a coated thin film 212 underneath the plasma discharge system 100. The portion of the material 140 susceptible to the secondary electric field have been adsorbed to the second surface of the thin film 210 facing the material 140. The attraction and adsorption steps of the non-contact printing system 100 can occur on short time scales. Non-limiting examples of the timescales of the attraction and adsorption steps include from about 1 millisecond to about 1000 milliseconds (e.g., about 1 millisecond to about 500 milliseconds, about 1 millisecond to about 250 milliseconds, about 1 millisecond to about 100 milliseconds, or about 1 millisecond to about 50 milliseconds).

Referring further to FIG. 2C, a coated thin film 212 is shown after undergoing non-contact material printing system 200 process. Individual particles 142 of the material 142 have been adsorbed to the thin film 210 to form the coated thin film 212. In some embodiments, the coated thin film 212 can be covered with a protective substrate 220. In some embodiments, the protective substrate 220 can be a second thin film 210 of a same material as the first thin film 210 or of a different material. In some embodiments, the protective substrate 220 may span a portion of the face of the coated thin film 212, or it may span the total area or more of the face of the coated thin film 212. In some embodiments, one or more protective substrates 220 can be used to cover the coated thin film 212.

FIG. 2C further shows, enlarged and inset, a material network 214 that can be created on the adsorbed surface of the coated thin film 212. The individual particles 142 can substantially be in contact to form the material network 214. The individual particles 142 can substantially be in contact to form the material network 150. The material network 142 can substantially be randomly dispersed on the surface of the substrate. The material network 214 can span a portion or all of area of the surface of the coated thin film 212. The material network 214 can be created from one or more materials 140 (e.g., two or more, three or more, four or more). The material network 150 can be created to form a material 140 density on the substrate 130 from about 1% to about 100% (e.g., about 1% to about 100%, about 15% to about 85%, about 30% to about 70%, about 45% to about 55%, about 50% to about 100%, about 1% to about 50%).

Once the material network 150 has been created on the coated thin film substrate 132, one or more electrodes 160 can be attached to the material network 150 (e.g., two or more, three or more, four or more). In some embodiments, the electrodes 160 can be made of a conductive material. Non-limiting examples of the electrode 160 conductive material can be silver, copper, tungsten, gold, titanium, or alloys thereof. In some embodiments, the electrodes 160 can be made of a non-conductive material coated in a conductive material. For example, the electrodes 160 can be made from a non-conductive polymer thread that is coated in a conductive material as described herein. In some embodiments, the electrode can be made from a conductive polymer (e.g., polyacetylene, poly(phenylene vinylene), poly(3,4-ethylenediox-ythiophene): polystyrene sulfonate (PEDOT:PSS)) or conductor-impregnated polymers.

The one or more electrodes 160 can be attached to one or more point on the material network 150 (e.g., two or more, three or more, four or more). In some embodiments, the one or more electrodes 160 can be attached to one or more boundary of the material network 150 (e.g., two or more, three or more, four or more). The one or more electrodes can be attached with a conductive adhesive. Non-limiting examples of the conductive adhesive can be pastes of conductive metals (e.g., silver, gold, copper, or graphite) suspended in a solvent (e.g., propylene glycol acetate, ethanol, or acetone).

In some embodiments, the coated thin film substrate 132 can be covered with a protective layer 170. In some embodiments, the protective layer 170 can be a second thin film 210 of a same material as the first thin film 210 or of a different material. In general, the protective layer can be made of a non-conductive material (e.g., insulative material). In some embodiments, the protective layer 170 can be made of any polymer described herein. In some embodiments, the protective layer 170 may span a portion of the face of the coated thin film substrate 132, or it may span the total area or more of the face of the coated thin film substrate 132. In some embodiments, one or more protective substrates 170 can be used to cover the coated thin film substrate 132.

Once the coated thin film substrate 132 with connected electrodes 160 has been covered with the protective layer 170, this can be called a flexible sensor 200.

In some embodiments, the flexible sensor 200 can be about 1 μm to about 3000 μm thick (e.g., about 50 μm to about 2500 μm, about 100 μm to about 2000 μm, about 500 μm to about 1500 μm, about 750 μm to about 1000 μm, about 1 μm to about 2500 μm, about 1 μm to about 1000 μm, about 50 μm to about 500 μm, or about 5 μm to about 150 μm). In some embodiments, the flexible sensor 200 can be more than 100 μm to more than 1 mm thick (e.g., more than 100 μm to more than 1 mm, more than 300 μm to more than 1 mm, more than 600 μm to more than 1 mm, more than 900 μm to more than 1 mm, more than 100 μm to more than 900 μm, more than 100 μm to more than 600 μm, more than 100 μm to more than 600 μm, or more than 100 μm to more than 300 μm).

In some embodiments, the flexible sensor 200 can be about 3000 μm or less (e.g., 2500 μm or less, 2200 μm or less, 2000 μm or less, 1600 μm or less, 1500 μm or less, 1200 μm or less, 1000 μm or less, 800 μm or less, 500 μm or less, 250 μm or less, 200 μm or less, 100 μm or less, 70 μm or less, 60 μm or less, 50 μm or less, 40 μm or less, 30 μm or less, 20 μm or less, or 10 μm or less).

In some embodiments, the flexible sensor 200 can weigh about 10 g or less (e.g., 10 g or less, 8 g or less, 6 g or less, 4 g or less, 2 g or less, 1 g or less, 100 mg or less, 10 mg or less, or 1 mg or less).

In general, the flexible sensors 200 can be configured to monitor one or more parameters. In some embodiments, the flexible sensors 200 can be configured to monitor one or more physiological parameters (e.g., skin conductivity, glucose, oxygenation, electrical activity, heart rate, respiration, oculogyration, sleep wake patterns, temperature, neurological activity, oxygen saturation, eye blinking, facial expressions, vocal vibrations, mouth movements, swallowing, elbow movements, arm movement, hand pressure, or foot pressure). In some embodiments, the flexible sensors 200 can be configured to monitor a physiological parameter for monitoring a patient's health.

In some embodiments, the flexible sensors 200 can be configured to monitor one or more chemical signals (e.g., pH, chemical presence, humidity).

In some embodiments, the flexible sensors 200 can be configured to sense an electrical signal (e.g., current, potential, impedance, or capacitance).

In some embodiments, the thin film substrate 130 may be masked before being processed through the material printing system 100. In some embodiments, the thin film substrate 130 may be masked during the material printing system 100 process. The mask can prevent adsorption of the material 140 onto the face of the thin film substrate 130 in selected regions. The masked regions may be of any size up to the spatial dimensions of the thin film substrate 130. Further, the masked regions may be of any shape. For example, the masked region may be a geometric shape, letter, numeral, image, or any combination thereof. More than one mask may be used in the production of a masked coated thin film substrate 132.

In general, the mask can be any non-conductive material but an exemplary material can be a polymer sheet as described herein. In general, the mask can be situated between the substrate 130 and the material 140. One or more masks can be used in the production of a flexible sensor 200. The one or more masks can have the same pattern or different patterns. One or more masks can be used in combination with one or more material 140 in the flexible sensor 200. The mask can be made from the same material as the flexible sensor 200 or a different material. In some embodiments, the mask can be made from a thin film substrate 130.

Flexible sensors 200 produced from masked coated thin film substrates 132 can have one or more of the selected regions attached to electrodes.

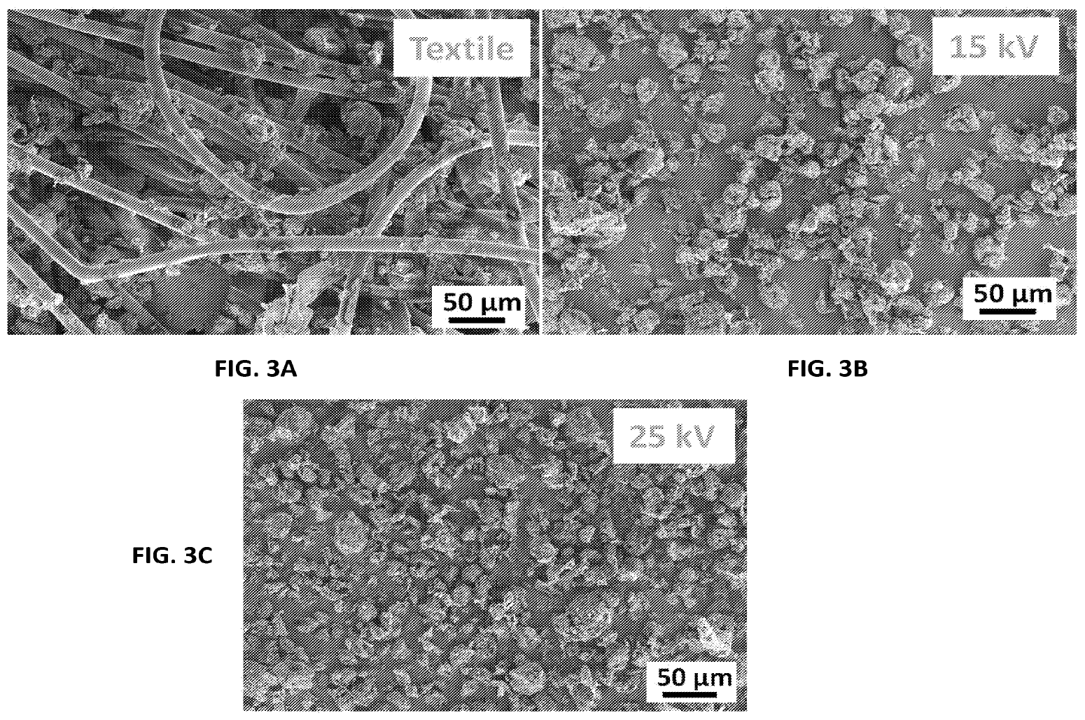

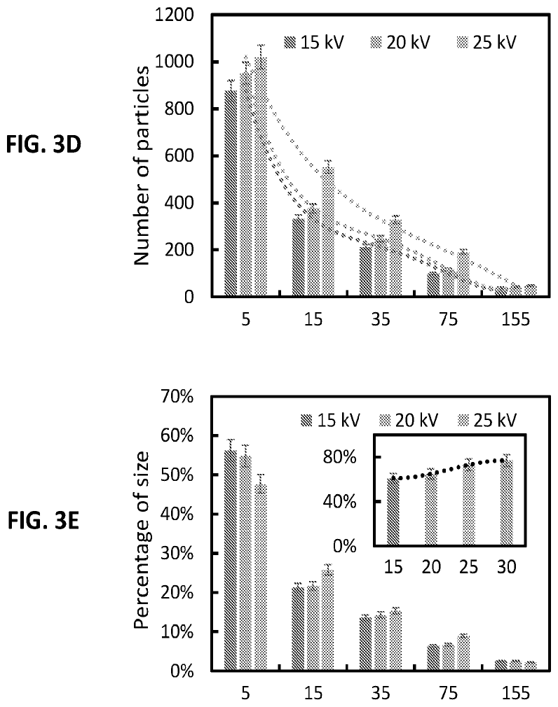

It was discovered that the CEP procedure can be controlled by the corona discharging voltage and is selective to different particle sizes. Specifically, comparing FIG. 3B printed by 15 kV corona voltage with FIG. 3C printed at 25 kV, and based on the statistics in FIG. 3E, an increase of size and number of particles was observed with the increase of corona voltage. The statistic of the particle distribution in FIG. 3F shows that with increasing voltage, the percentage of smaller particles decreases, while the percentage of larger particles increases. This means that higher voltage attracts larger particles.

With the voltage increase, the percentage of the substrate area covered by the printed materials also increases, which is˜61% for 15 kV and ˜77% for 30 kV (FIG. 3F inset). For all the above tested CD voltages, over 93% of printed particles are less than 50 μm. FIG. 3A is a demonstration showing the substrate printed by CEP is not only limited to flat surfaces. The electrostatic force can also push the particles into complex 3D structures of non-woven fabrics, expanding the printable substrate choices.

FIGS. 3A through FIG. 3D further demonstrate that the composition of the microstructure of the material network 214 can be controlled though discharge electrode 110 voltage. In particular, FIGS. 3A-3C provide scanning electron microscope (SEM) images of exemplary material networks 214 after a substrate 130 has been treated with the non-contact material printing system 200 process using graphene as the inducted material 140. The material networks 214 depicted in FIGS. 3A-3C are grapheme networks but in general, can be any material listed herein.

FIG. 3A depicts an SEM image of a nonwoven textile after treatment with the non-contact material printing system 200 process. The long fibrous elements 310 are the fibers of the textile and the granular structures are individual particles 142 of the material 140 adsorbed to the microstructure of the nonwoven textile. Inset at the bottom left of the image is a scale bar where the length of the bar represents a distance of 50 μm.

FIG. 3B depicts an SEM image of a target substrate after treatment in the non-contact material printing system 200 at a discharge electrode 110 voltage of 15 kV using graphene as the inducted material 140. The granular structures are individual particles 142 of the material 140 adsorbed to the face of the substrate opposite to the discharge electrode 110 and the unabsorbed regions 312 are areas where individual particles 142 did not adsorb. Inset in the upper right of the image is the voltage the discharge electrode 110 was maintained at for the duration of the adsorption process (e.g., 15 kV as shown).

Referring to 0FIG. 3C, a SEM image is provided of a target substrate after treatment in the non-contact material printing system 200 at a discharge electrode 110 voltage of 25 kV. FIG. 3C allows a visual comparison of the material network 214 to FIG. 3B. FIG. 3C depicts a material network 214 with a denser population of individual particles 142 and fewer and smaller unabsorbed regions 312. The scale bar inset in both FIG. 3B and FIG. 3C represents a distance of 50 μm. FIGS. 3B and 3C demonstrate that the discharge electrode 110 voltage can influence the microstructure of the material network 214 adsorbed to a substrate after treatment in the non-contact material printing system 200.

0D and 3E are bar charts showing that the voltage of the discharge electrode 110 within the non-contact material printing system 200 can affect the microstructure of the material network 214 by creating variations in size and density distribution of the particle population attracted to the substrate.

FIG. 3D is a bar chart of collected compares the number of particles on a substrate surface to the average particle size. The images of FIGS. 3A through 3C was analyzed to determine the average particle size and binned into five particle size ranges (e.g., 5 μm, 15 μm, 35 μm, 75 μm, 155 μm) and at three discharge electrode 110 voltages (e.g., 15 kV, 20 kV, 25 kV). The number of particles in each size range is represented by three scale bars (e.g., a left, center, and right scale bar). The left, center, and right scale bar represents the normalized fraction of the total size distribution with a conductive electrode voltage of 15 kV, 20 kV, and 25 kV, respectively. The dashed lines connects the average values of the respective bars to the bars at the same voltage in the other size ranges.

FIG. 3E is a bar chart of collected data compares the percentage of particle size on a substrate surface to the average particle size. The images of FIGS. 3A through 3C was analyzed to determine the average particle size and binned into five particle size ranges (e.g., 5 μm, 15 μm, 35 μm, 75 μm, 155 μm) and at three discharge electrode 110 voltages (e.g., 15 kV, 20 kV, 25 kV). The percentage of particle size distribution in each size range is represented by three scale bars (e.g., a left, center, and right scale bar). The left, center, and right scale bar represents the normalized fraction of the total size distribution with a conductive electrode voltage of 15 kV, 20 kV, and 25 kV, respectively.

Inset in the upper left corner of FIG. 3E is a second chart comparing discharge electrode 110 voltages and the density of material 140 in the material network 214. The density is a measure of the normalized percentage coverage of a unit area (e.g., μm²) on the substrate. The coverage was determined by measuring the area covered by the material network 214 and dividing by the total area depicted in an image. From left to right, a discharge electrode 110 voltage of 15 kW, 20 kV, 25 kV, and 30 kV are shown as bars ranging from ˜0.6 to ˜0.8. This is representative of the effect that higher discharge electrode 110 voltages can achieve higher material network 214 densities.

In some embodiments, the thin film 210 may be masked before being processed through the material printing system 200. The mask can prevent adsorption of the material 140 onto the face of the thin film 210 in selective regions to create regions of selective material 140 on the thin film 210. In general, the mask can be any non-conductive material but an exemplary material can be a polymer sheet as described herein. In general, the mask can be situated between the substrate 130 and the material 140. The mask can be stationary or can move as needed in the material printing system 200. One or more masks can be used in a material printing system 200. The one or more masks can have the same pattern or different patterns. One or more masks can be used in combination with one or more material 140 in the material printing system 200. The mask can be made from the same material as the substrate 130 or a different material. In some embodiments, the mask can be made from a thin film 210.

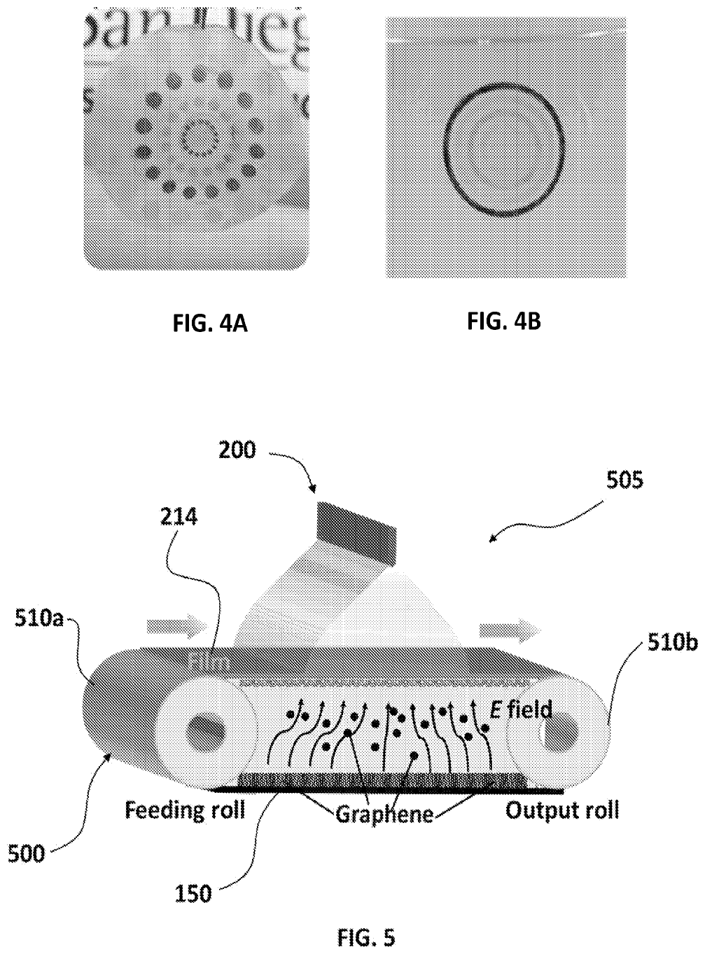

The masked regions may be of any size up to the spatial dimensions of the thin film 210. Further, the masked regions may be of any shape. For example, the masked region may be a shape, letter, numeral, image, or any combination thereof. More than one mask may be used in the production of a coated thin film 212. FIGS. 4A and 4B depict exemplary coated thin films 212 after masking and processing through the material printing system 200. One or more masks were used in combination with graphene and thermally responsive powders to create concentric designs.

FIG. 4A shows a first exemplary coated thin film 212 (e.g., medical tape) after the use of at least one mask to create four concentric annulus of material 140 that have been selectively adsorbed onto the thin film 210.

FIG. 4B shows second exemplary coated thin film 212 after masking and processing through the material printing system 200. Through the use of at least one mask, 5 concentric rings of material 140 have been selectively adsorbed onto the thin film 210. The concentric rings are demonstrated with a spacing in between each ring such that there is no overlap between concentric ring regions.

FIG. 5 depicts an embodiment of the non-contact material printing system 200 in use with a roll-to-roll (R2R) device 500 to form a R2R material printing system 505. The R2R device 500 is depicted in this embodiment as a conveyor with two cylindrical rolls 510, a feeding roll 510a and an output roll 510b. In general, the substrate 130 maybe in the form of a continuous sheet or a roll. In some embodiments, an R2R device 500 may use one or more sheets or rolls of substrate. FIG. 5 further depicts a continuous thin film 214 connecting the feeding roll 510a and the output roll 510b. The feeding roll may be a continuous thin film 214 rolled into a cylinder and the output roll 510b can be a roll used to collect the continuous thin film 214 after treatment in the R2R material printing system 505. As the feeding roll 510a and the output roll 510b are rotated, the connecting continuous thin film 515 may be transferred from one to the other, or vice versa. In some embodiments, there can be additional rolls 510 between the feeding roll 510a and output roll 510b that support or redirect the continuous thin film 214.

In general, as the R2R device 500 is operated the continuous thin film 214 can be fed over a zone containing material 140. The zone containing material 140 can be of any shape or volume that fits between the feeding roll 510a and output roll 510b of the R2R device 500. The material 140 used with an R2R material printing system 505 may be any material 140 as listed herein. In general, there can be a second or more zone containing material 140 in combination with a second or more non-contact material printing system 200.

In some embodiments, the material 140 can be applied to the continuous thin film 214 in a continuous manner. The R2R device 500 can be configured to provide a renewed supply of printing material. For example, the material 140 can be constantly fed into the R2R material printing system 505 through the use of a belt, an aerosol nozzle, or a fan. In this manner, the rate of application of the material 140 to the continuous thin film 214 can be controlled. In some embodiments, the rate of application of the material 140 can be controlled to the feed rate of the continuous thin film 214.

In some embodiments, the material 140 can be applied to the continuous thin film 214 through the use of an aerosol nozzle. In some embodiments, the aerosol nozzle can be charged to apply a charge to the material 140 to increase induction to the continuous thin film 214, as described above. In some embodiments, the aerosol nozzle can use a pressurized gas to apply the material 140 to the continuous thin film 214. For example, the pressurized gas used in the aerosol nozzle can be pressurized air.

The discharge electrode 110 shown in 0 5 is depicted as a wire, but the discharge electrode 110 used in a non-contact material printing system 200 with a R2R device 500 may be of any shape or make listed herein.

One or more materials 140 may be adsorbed onto partially or fully the same areas on the continuous thin film 214a. In some embodiments, there may be a masking process in one or more of the material printing systems 200 such that the one or more materials 140 are in specific regions that may overlap or may be spatially distinct. The masked regions may be of any region or dimension listed herein.

In general, one or more materials 140 may be adsorbed onto partially or fully the same areas on the continuous thin film 214a under a single material printing system 200 if sources of materials 140 are exchanged between printing processes.

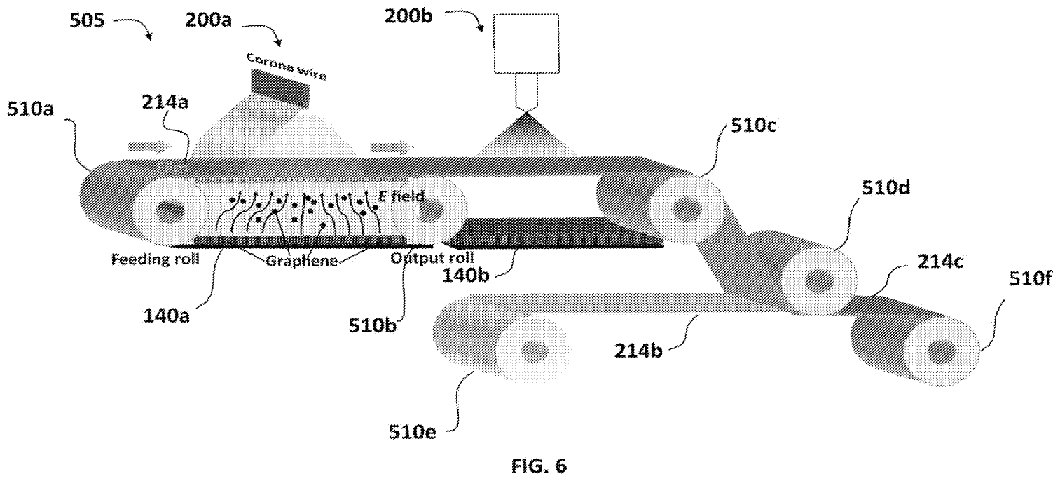

FIG. 6 depicts a further embodiment of the R2R material printing system 505 using additional rolls 510 and material printing systems 200 to form a second exemplary R2R material printing system 505. In the depicted embodiment, a first material printing systems 200 is positioned above a R2R device 500 and above a first zone containing material 140a. The discharge electrode 110 shown in the first material printing systems 200a is depicted as a wire, but the discharge electrode 110 used in a non-contact material printing system 200 with a R2R device 500 may be of any shape or make listed herein. The first material printing systems 200a is then activated to draw a portion of the first material 140a to the continuous thin film 214a. The portion of the first material is then adsorbed onto the surface oriented toward the first material 140a.

The continuous thin film 214a is then fed between a feeding roll 510a and the output roll 510f. In general, there can be one or more additional rolls between the feeding roll 510a and the output roll 510f. The one or more additional rolls may support, redirect, or add one or more additional thin films 210, or any combination thereof, to the R2R material printing system 505.

FIG. 6 depicts the continuous thin film 214a continuing over a first additional roll 510b, and passing under a second material printing systems 200b. The second material printing systems 200b is positioned above a R2R device 500 and above a second zone containing material 140b. The discharge electrode 110 shown in the second material printing systems 200b is depicted as a needle, but the discharge electrode 110 may be of any shape or material listed herein. The second material printing systems 200b is then activated to draw a portion of the second material 140b to the continuous thin film 214a and the portion of the second material 140b adsorbed onto the surface oriented toward the second material 140b.

As further depicted in FIG. 6, after the continuous thin film 214a has been processed by the second material printing systems 200b, the continuous thin film 214a can continue over a third roll 510c to be redirected to a fourth roll 510d.

In general, one or more additional feeding rolls 510a may add one or more additional continuous thin films 214b to the first continuous thin film 214a being processed in the R2R material printing system 505. FIG. 6 depicts a second feeding roll 510e with a second continuous thin film 214b that can be laminated with the first continuous thin film 214a by passing over the fourth roll 510d concurrently. This process forms a laminated continuous thin film 214c.

In general, the one or more additional continuous thin films 214 can partially or fully cover the first continuous thin film 214a. In some embodiments, more than one continuous thin film 214 can be laminated to the first continuous thin film 214a to partially or fully cover the first continuous thin film 214a. In general, the one or more additional continuous thin films 214 can have an adhesive surface to strengthen the lamination of the one or more additional continuous thin films 214 to the first continuous thin film 214a.

Referring again to FIG. 6, the laminated continuous thin film 214c is depicted as being transferred onto a terminal output roll 510f.

In general, the R2R material printing system 505 can be operated continuously (e.g., without stop), or it can be operated in a manner to stop and start selected areas of the continuous film 214 at selected locations within the R2R material printing system 505. For example, the R2R material printing system 505 can be operated such that one or more selected areas of the continuous film 214 may be stopped beneath one or more non-contact material printing systems 200 of the R2R material printing system 505.

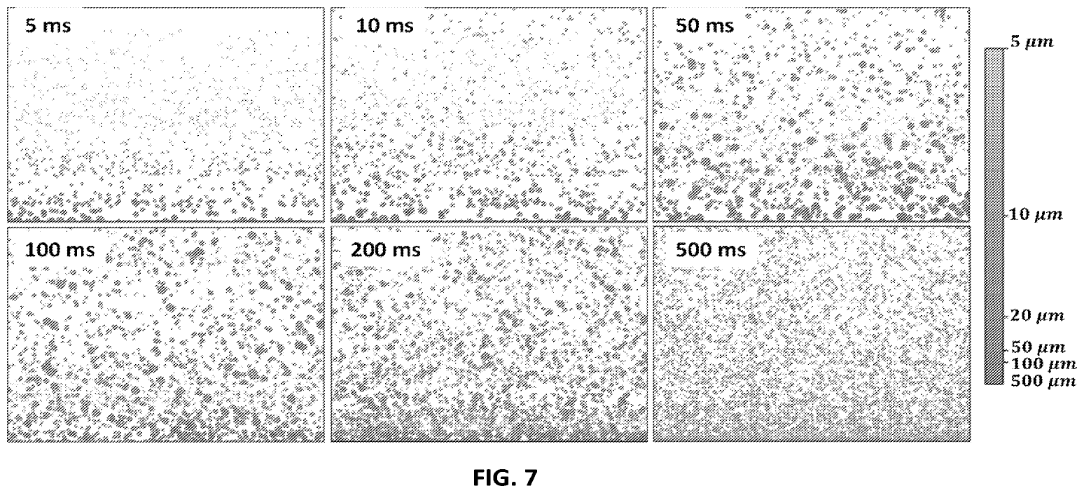

Simulations were performed to determine the characteristic motion of source material particles exposed to the generated electric field. FIG. 7 is a series of six simulated images of the dynamic material transfer process, with darker color and dot size representing larger particles. The scale bar on the left of FIG. 7 depicts the size-color for the individual particle sizes of the images, where darkest grey represents particles of 500 μm in diameter to light grey representing particles 5 μm in diameter. The vertical height of each image represents a simulated distance between the substrate at the top of the image and the material source at the bottom of the image, the simulated distance being 10 mm. The horizontal length of the image represents a simulated distance of 10 mm.

The images represent the simulated particle spatial distributions traveling upward from the material resource to the substrate at the top surface. A simulated electric field is applied across the substrate and each image corresponds with a time period after the electric field is applied. From the upper left image of FIG. 7 and proceeding clockwise, the images represent a time period of 5 ms, 10 ms, 50 ms, 500 ms, 200 ms, and 100 ms, respectively.

At 5 ms (upper left), a portion of simulated particles move upwards toward the upper substrate. Simulated particles having the smallest diameter are closest to the substrate. At 10 ms (upper middle), particles in the range of 5 μm to 10 μm arrive at the substrate while particles over 20 μm in diameter raise from the material resource (e.g., the bottom of the image). At 50 ms (upper right), the portion of simulated particles of 20 μm and greater arrive at the simulated substrate surface. At 100 ms (bottom left), the size of the simulated particles arriving at the simulated substrate surface and departing the material are approximately similar, including a portion of all size ranges from less than 5 μm to over 100 μm. At 200 ms (bottom middle), the simulated particle size undergoing motion reduces to around half of those depicted at 100 Ms. At 500 ms (bottom left), the simulated particle size undergoing motion reduces to less than 10 μm.

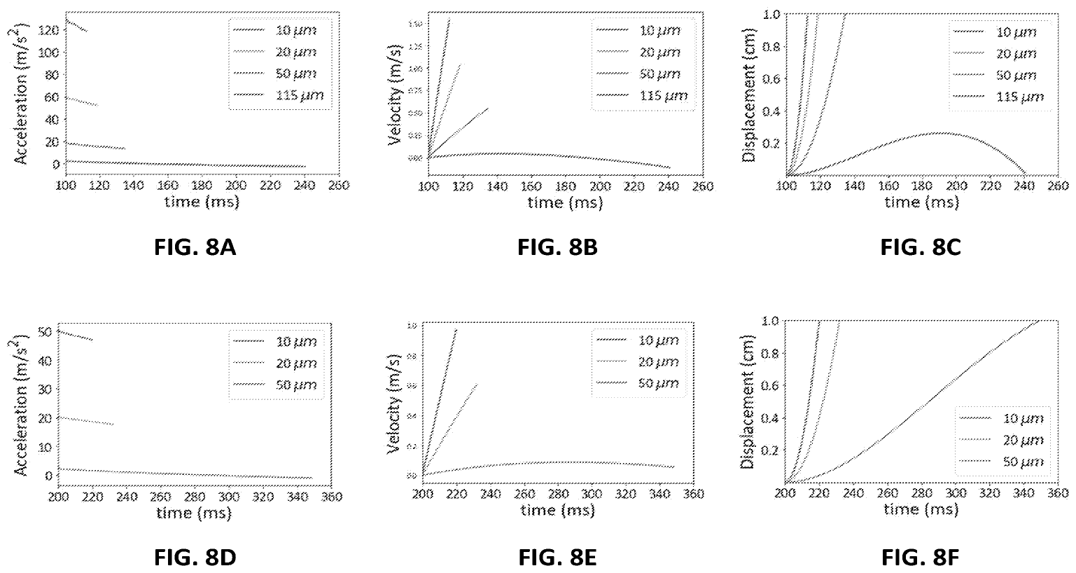

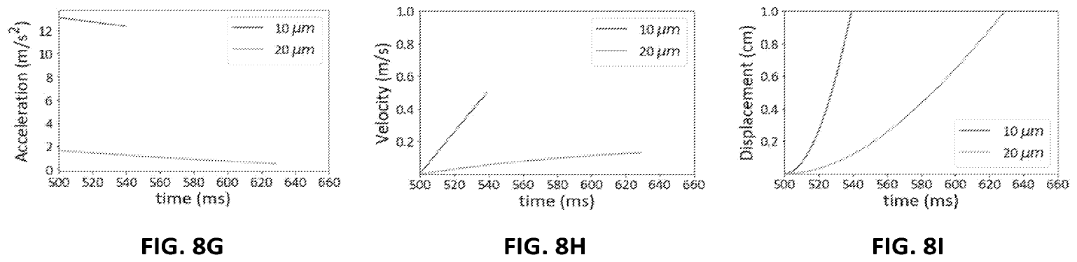

FIGS. 8A through 81 are line charts showing calculated average accelerations, average velocities, and average displacements on the y-axes of simulated particles having a given diameter over time on the x-axes. Accelerations are shown in m/s², velocities in m/s, and displacements in cm. The key inset to each of FIGS. 8A through 8I shows which simulated particle diameters are shown in the chart. The four simulated particle diameters are 10 μm, 20 μm, 50 μm, and 115 μm. The individual lines of FIGS. 8A through 8I show the average simulated values of the simulated particle diameters across time and terminate when the simulated particles arrive at the substrate (e.g., the top of the images of FIG. 7).

FIGS. 8A to 8C depict the average accelerations, average velocities, and average displacements of all four simulated particles diameter groups, FIGS. 8D to 8F depict the average accelerations, average velocities, and average displacements of three simulated particles diameter groups (e.g., 10 μm, 20 μm, and 50 μm), and FIGS. 8G to 8I depict the average accelerations, average velocities, and average displacements of two simulated particles diameter groups (e.g., 10 μm, and 20 μm).

FIGS. 8A to 8C represent the behavior of simulated particles at 100 ms during the simulation of FIG. 7. Smaller particles (e.g., 10 μm) have larger initial calculated accelerations due to smaller mass. 10 μm simulated particles arrive at the substrate within 12 ms; 20 μm simulated particles arrive at the substrate within 16 ms; and 50 μm simulated particles arrive at the substrate within 30 ms.

In general, the acceleration for all simulated particle diameters reduces as more material arrive at (e.g., cover) the substrate during the simulated CEP process, which reduces the electric field and upward attraction force. With reference to FIG. 8A and 8B, the acceleration and velocity values of 115 μm simulated particles became negative at ˜90 ms. after positive acceleration and velocity values (e.g., traveling upwards) for ˜0.3 cm, referring to FIG. 8C, the slope of the particle displacement reduces.

At 200 ms, the average acceleration of all particles reduced compared with the ones started from 100 ms. The initial acceleration of the 10 μm simulated particle was reduced to ˜50 m/s², and 20 m/s² for 20 μm simulated particles. The largest simulated particle in this time frame is ˜50 μm which takes ˜150 ms to arrive at the substrate, and its average acceleration is reduced to almost 0 when it arrives at the substrate. For 500 ms, upward movement occurs in particles smaller than ˜20 μm. It takes as long as 130 ms for a 20 μm particle to arrive at the substrate with much lower acceleration and velocity than other simulated particles.

From the above analysis, the material attraction process during CEP is a dynamic and selective process. At the beginning, the electric field is strong, and materials begin to accelerate to the targeted substrate at high speed. Particles reach the upper substrate starting from smaller ones. Larger particles arrive the substrate with time goes on. The voltage of corona is the major factor controlling the maximum electric force applied on the materials and determining the largest particle size being selected. With more materials covering the substrate, the electric field strength drops, with the attracted particle size and amount dropping as well. The material transfer process in CEP can be finished within ˜200 ms, meaning CEP is an ultra-fast and controllable material transfer process without utilizing liquid status media.

II. Printed Sensors

Described herein are printed sensors, and more particularly to sensors manufactured using non-contact printing methods of materials using an electric field.

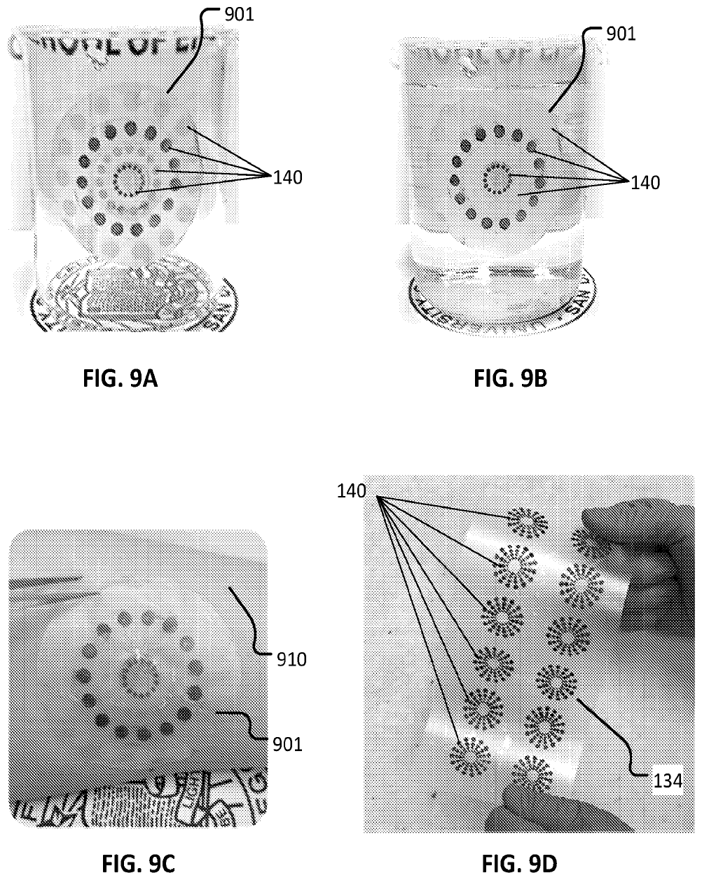

FIG. 9A shows an exemplary flexible sensor 901 after masking and processing through the material printing system 100. Through the use of at least one mask, five concentric rings of circles of one or more materials 140 have been selectively adsorbed onto the thin film substrate 130. The concentric rings are demonstrated with a spacing in between each ring such that there is no overlap between concentric ring regions. The flexible sensor 901 is depicted affixed to a glass beaker substrate. The flexible sensor 901 is depicted at room temperature.

FIG. 9B shows the flexible sensor 901 affixed to the glass beaker substrate after the glass beaker has been filled with hot water. Comparing FIG. 9A to FIG. 9B shows color differences between the flexible sensor 901. The thermochromic powders used in the production of the flexible sensor 901 are shown to respond to temperature changes.

FIG. 9C depicts a flexible sensor 901 after placement upon the skin 910 of a subject. A flexible sensor 900 affixed to the skin 910 of a subject may be called a wearable flexible sensor 901. Comparing FIG. 9A to FIG. 9C shows color differences between the flexible sensor 901 responding to the different in room and skin temperatures.

In some embodiments, a material printing system 100 may use a roll-to-roll system, such as the R2R device 500 of FIG. 5, to produce continuous thin film substrates 134. A roll-to-roll material printing system (e.g., material printing system 200) can use one or more sources of material 140, one or more continuous rolls of thin film substrate 134, one or more plasma discharge apparatus 105, and one or more masks to produce a masked coated continuous thin film substrate 134. FIG. 9D depicts a first exemplary continuous thin film substrate 134 with multiple areas of patterned adsorbed material 140. The adsorbed material 140 of FIG. 9D is four concentric rings of dots of decreasing radius.

Flexible sensors 900 can be used in a number of sensory systems. Non-limiting examples of flexible sensor 900 sensory systems can be stress, strain, torsion, pressure, or temperature. Further figures will be used to describe non-limiting examples of flexible sensor 900 sensory systems.

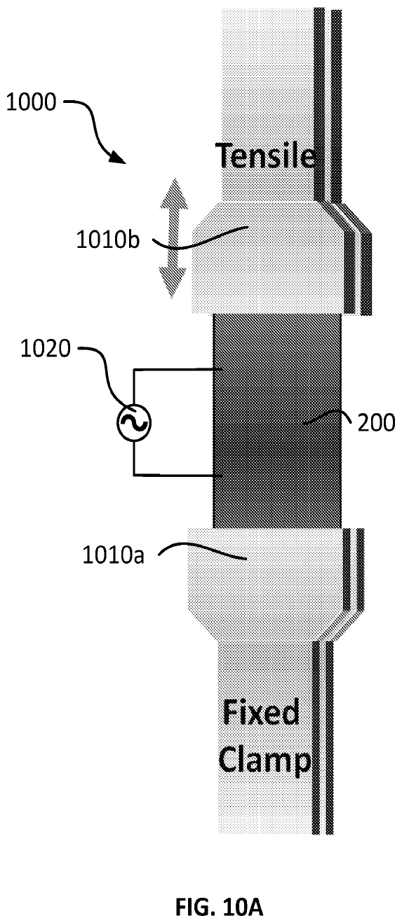

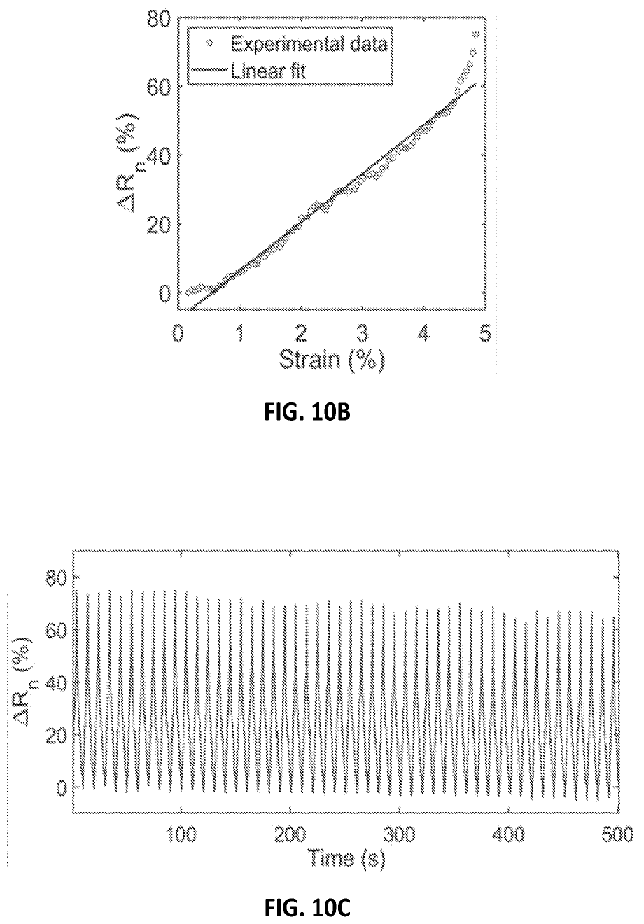

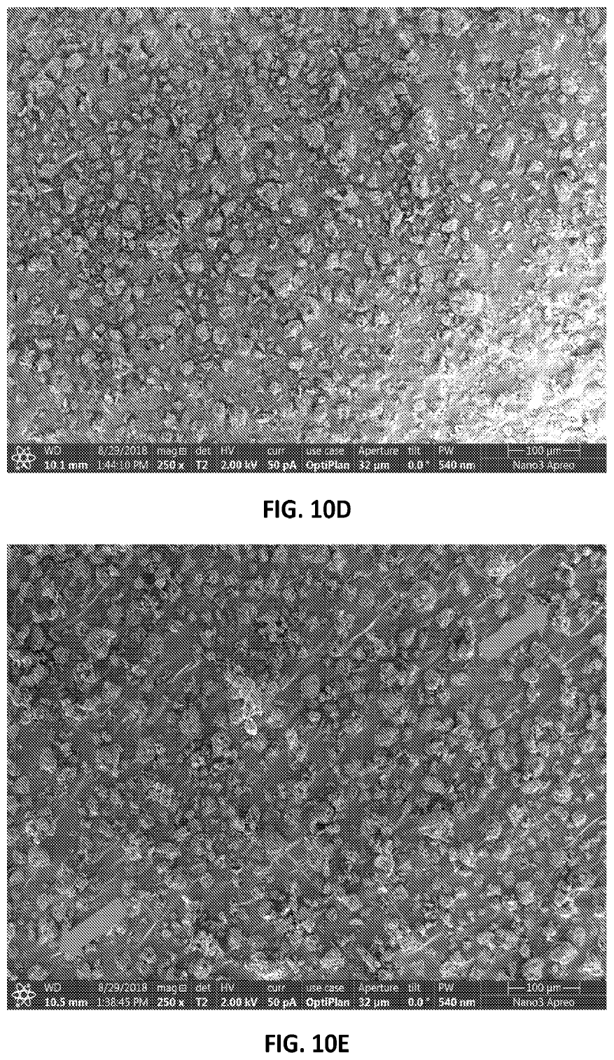

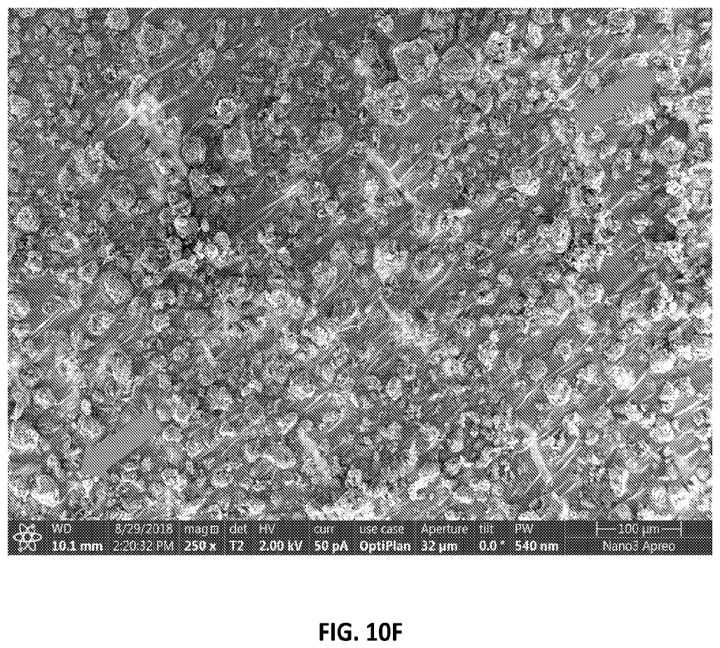

FIG. 10A depicts a uniaxial strain system 1000 with a flexible sensors 200. The uniaxial strain system 1000 is depicted comprised of two clamping armatures, a stationary clamping armature 1010a and a bidirectional clamping armature 1010b. The bidirectional clamping armature 1010b can provide a relative proximal or distal longitudinal motion to the stationary clamping armature 1010a. The flexible sensor 200 is depicted clamped between the clamping armatures, 1010a and 1010b, so that no slipping between the flexible sensors 200 and the clamping armatures may occur and any motion along the longitudinal axis of the bidirectional clamping armature 1010b induces strain in the flexible sensors 200.

In some embodiments, the flexible sensor 900 can have a strain sensitivity of about 1 to about 100 (e.g., about 5 to about 50, or about 10 to about 25). In some embodiments, the flexible sensor 200 can have a strain sensitivity of about 400 or less (e.g., about 400 or less, about 350 or less, about 300 or less, about 250 or less, about 200 or less, about 150 or less, about 100 or less, about 50 or less, about 30 or less, about 10 or less, or about 5 or less).

The flexible sensor 200 in the uniaxial strain system 1000 can detect static, constant, or cyclic strain, or a combination therein. FIG. 10B depicts a graph comparing the normalized change in resistance (ΔRn) to strain. The x-axis shows the strain in percentage points from 0 to 5% strain. The y-axis shows the normalized change in resistance of the flexible sensor 200. The electrical resistivity of the flexible sensor 200 can be measured and recorded using a digital multimeter 1020. An initial resistivity measurement can be taken from the flexible sensor 200 under zero strain (R₀) and each measurement in the set of data points can be transformed with the following equation ΔRₙ=(Rᵢ−R₀)/R₀. The dots within the chart are a series of data points of measured resistivity as the strain was applied at a rate of 1% strain s⁻¹. The line overlaying the dots is a linear fit to the data points.

FIG. 10C depicts a graph comparing ΔRₙ through time when a cyclic uniaxial strain is applied. The x-axis shows a time course in seconds (s) from 0 to 500 s. The y-axis shows the normalized change in resistance of the flexible sensor 200, as detailed above. The flexible sensor 200 is subjected to cyclic longitudinal motion of the bidirectional clamping armature 1010b and the resistivity of the flexible sensor 200 is measured. The uniaxial strain system 1000 was cycled from 0% strain to a maximum strain of 5% at a rate of 1% strain s^{-1.}

FIGS. 10D to 10F depict scanning electron micrograph (SEM) images of exemplary material networks 150 formed on a flexible sensor 200. FIGS. 10D to 10F are taken with increasing amounts of strain on the flexible sensor 200. The field of view of the image is about 1000 μm by about 550 μm.

FIG. 10D depicts an SEM image of a material network 150 on a flexible sensor 200 under 0% strain.

FIG. 10E depicts an SEM image of a material network 150 on a flexible sensor 200 under 5% strain. The load direction is axial with the arrows depicted in the corners of the image. Without wishing to be bound by theory, as the individual particles 142 of the material network 150 become more spatially separated and the density decrease with increasing strain, the resistivity of the material sensor 200 can change.

FIG. 10F depicts an SEM image of a material network 150 on a flexible sensor 200 under 10% strain. The load direction is axial with the arrows depicted in the corners of the image.

In some embodiments, the flexible sensor 200 can withstand (e.g., be strained without breaking) a strain of about 200% or less (e.g., 200% or less, 180% or less, 160% or less, 140% or less, 120% or less, 100% or less, 80% or less, 60% or less, 40% or less, or 20% or less).

For the flexible sensor 200 microstructures, observed piezoresistive response resulted from the deformation-induced alternation in the microstructures of the binder-free networks. In particular, the applied tensile strains could decrease the global electrical conductivity of the graphene patterns through disturbing the graphene network connections. However, the disturbed network connections could restore to their initial state when the strains were unloaded, which was demonstrated by the aforementioned reversible electromechanical response.

In order to validate the tension-induced change in the microstructures of the graphene networks, the digital image correlation (DIC) technique was employed to map the displacements and strains of the graphene networks in a non-contact manner. The DIC technique, as an optical metrology technique, has been used to quantify the deformations of objects based on digital image processing and numerical computing.

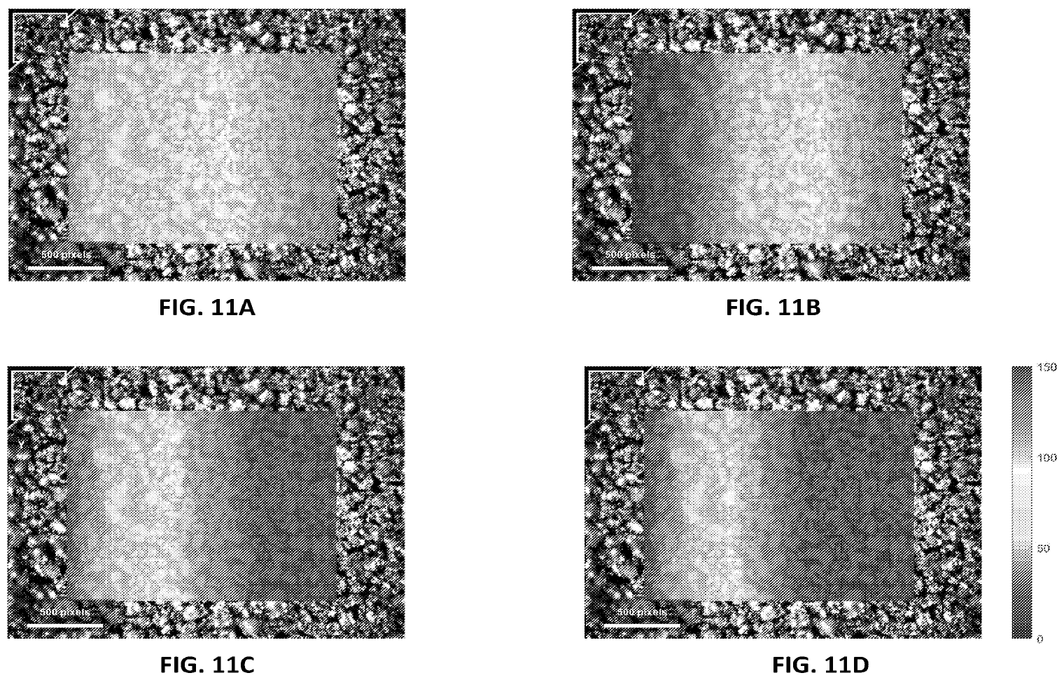

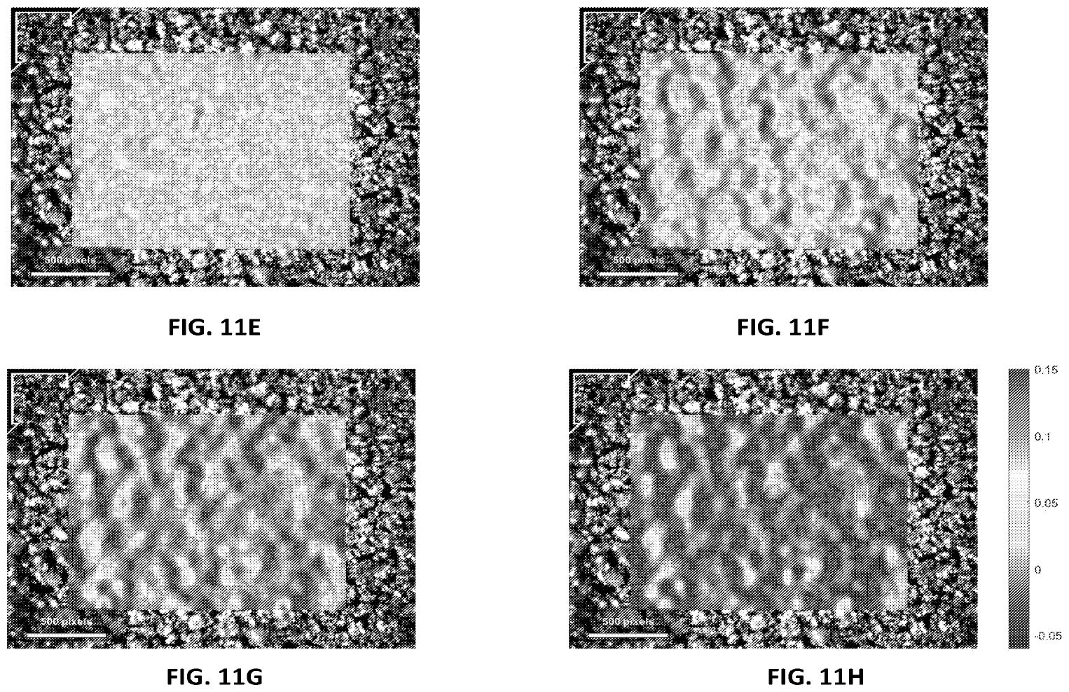

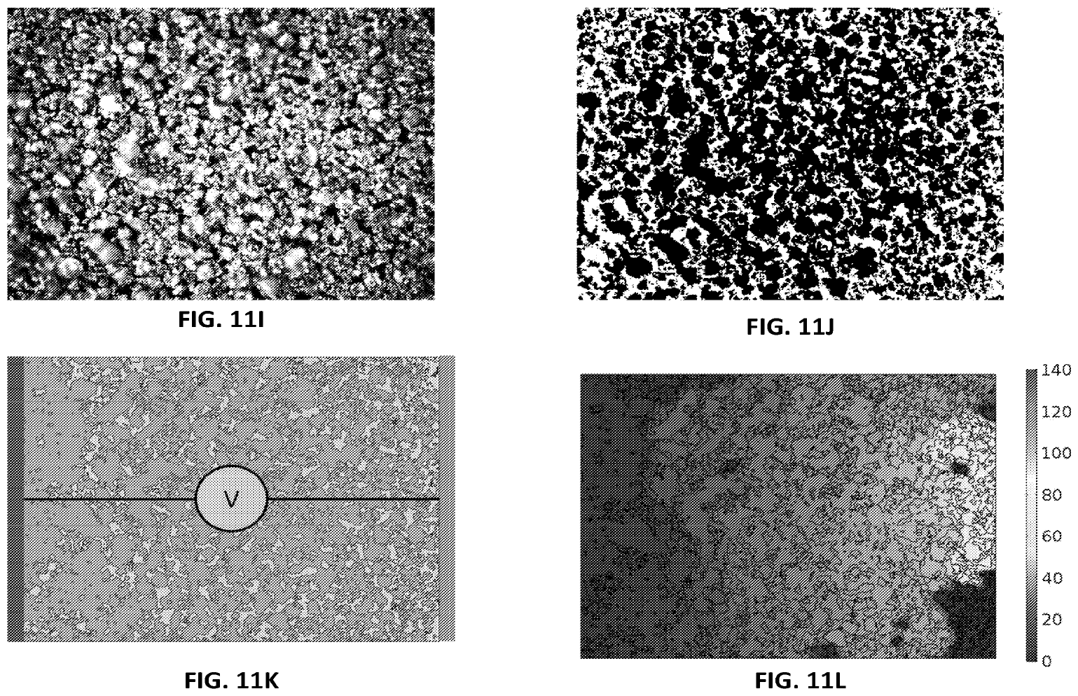

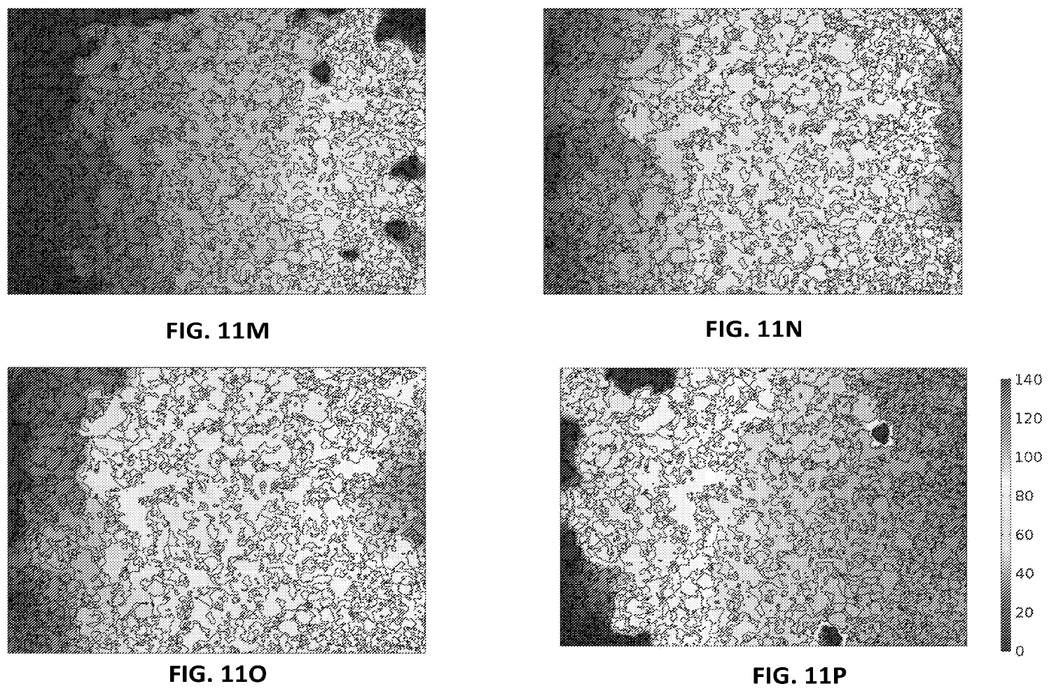

Typically, the surfaces of objects need to incorporate laser or white-light speckle patterns that could transfer the displacement information to the DIC method. Here, the DIC analysis was conducted based on the in-situ microscopic optical images of the graphene networks, where the graphene particles were directly used as the speckles for tracing the displacements of the networks. The in-situ optical images in FIGS. 11A through 11L were taken from the graphene patterns fabricated using a charging voltage of 25 kV.

FIGS. 11A through 11D show the horizontal displacement fields of the graphene network when it was subjected to 5%, 10%, 15%, and 20% uniaxial tensile strains, respectively. The moving clamp (arranged on the right-hand side of FIGS. 11A through 11D) applied uniform displacement to the graphene network. In addition, strains were calculated by displacements (evaluated using DIC) divided by the initial dimensions of the images, and the horizontal strain (εx) maps are shown in FIGS. 11E through 11H, corresponding to FIGS. 11A through 11D, respectively. Since the graphene particles were assembled with no binder, it essentially isolated some of the graphene particles from each other. The DIC-based evaluated tensile strains relatively accurately corresponded to the practically loaded deformations.

FIGS. 11A through 11D depict optical images of the material network 150 on a flexible sensor 200 overlaid with DIC representations of displacement of the substrate beneath the material network 150. The scale bar to the right of FIG. 11D shows a scale of 0 at the bottom to 150 pixel displacement at the top. The images depict an increasing displacement from left to right as strain increases from 5% to 20%. FIG. 11A depicts an optical microscopy image overlaid with a range of displacement distribution from about 30 pixels to about 100 pixels. FIG. 11B depicts an optical microscopy image overlaid with a range of displacement distribution from about 0 pixels to about 120 pixels. FIG. 11C depicts an optical microscopy image overlaid with a range of displacement distribution from about 0 pixels to about 150 pixels. FIG. 11D depicts an optical microscopy image overlaid with a range of displacement distribution from about 0 pixels to about 150 pixels.

FIGS. 11A through 11H depict optical images of the material network 150 on a flexible sensor 200 overlaid with graphical representations. The images are produced by taking optical images of the material network 150 on a flexible sensor 200 and processed using digital image correlation (DIC), an image processing technique where speckle patterns are used to trace the deformation of a substrate. In these images, the randomly distributed graphene particles were directly used as speckles for tracing the displacements of the networks. The images in columns from left to right are taken while the flexible sensor 200 are under uniaxial strains of 5%, 10%, 15%, and 20%, respectively. The direction of uniaxial strain is from the left to the right in each image.

FIGS. 11E through 11H depict optical images of the material network 150 on a flexible sensor 200 overlaid with the change in displacement distributions of the substrate beneath the material network 150 evaluated using the DIC technique. The optical microscopy images and localized strain maps of FIGS. 11E through 11H correspond to the images and displacement maps directly above them, e.g., FIGS. 11A through 11D. The scale bar to the right of FIG. 11H shows a scale of about −0.05% at the bottom to about 0.15% at the top. FIG. 11E depicts an optical microscopy image and overlay with a range of strain from about 0% to about 0.1%. FIG. 11F depicts an optical microscopy image and overlay with a range of strain from about 0% to about 0.15%. FIG. 11G depicts an optical microscopy image and overlay with a range of strain from about 0% to about 0.15%. FIG. 11H depicts an optical microscopy image and overlay with a range of strain from about 0.05% to about 0.15%.

Finite element analysis (FEA) was performed based on actual microstructures of the graphene networks captured using the aforementioned in-situ microscopic optical imaging method, which demonstrated capable of characterizing the strain-caused microstructural changes in the graphene networks. FIGS. 11I through 11L show the electric potential field distributions across the graphene networks when subjected to 5%, 10%, 15%, and 20% tensile strains, respectively. It was found that as the graphene particles became more isolated, higher electric potential would be generated, which indicated an increase in bulk electrical resistance of the graphene network. Thus, the microstructure-based FEA validated that the deformation-induced reconfiguration of graphene network leads to the experimentally observed strain sensitive performance.

FIGS. 11I through FIG. 11L depicts a step-wise process of characterizing the strain-induced reconfiguration of the material network 150 on a flexible sensor 200 using microstructure-based finite element analysis (FEA). As compared to the conventional FE modeling approaches, microstructure-based FEA can account for the features of actual material microstructures so as to potentially enhance the simulation accuracy.

FIG. 11I depicts an optical images of the material network 150 on a flexible sensor 200. To characterize the microstructure, the optical microscopy image of the material network 150 shown in FIG. 11I were processed to enhance the contrast between individual particles and the substrate to produce FIG. 11J. As shown in FIG. 11J, individual particles of the material network 150 are shown in white and areas of exposed substrate are shown in black.

The features in FIG. 11J were the processed through reconstruction software to define geometric finite elements, as shown in FIG. 11K. Material properties were assigned to the individual graphene particles and the substrate and electrical potentials were simulated at the left and right edges of FIG. 11K.

FIG. 11K depicts a simulated electric potential field distribution for the optical image in FIG. 11I as calculated by mathematical software (i.e., COMSOL Multiphysics).

FIGS. 11M through 11P depict the simulated electric potential field distributions corresponding to the optical images depicted in FIGS. 11A through 11D respectively. FIGS. 11M through 11P depict the individual particles become more isolated in the material network 150 which can lead to higher electric potential, thereby leading to an increase in measurable bulk electrical resistance of the material network 150. The microstructure-based FEA can show that the deformation of the material network 150 can lead to the strain sensitive performance.

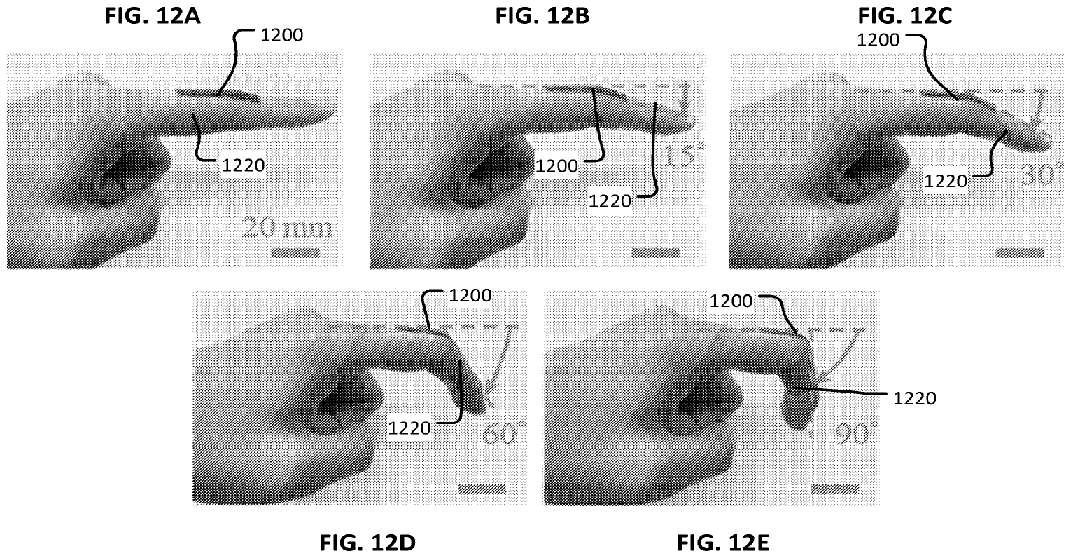

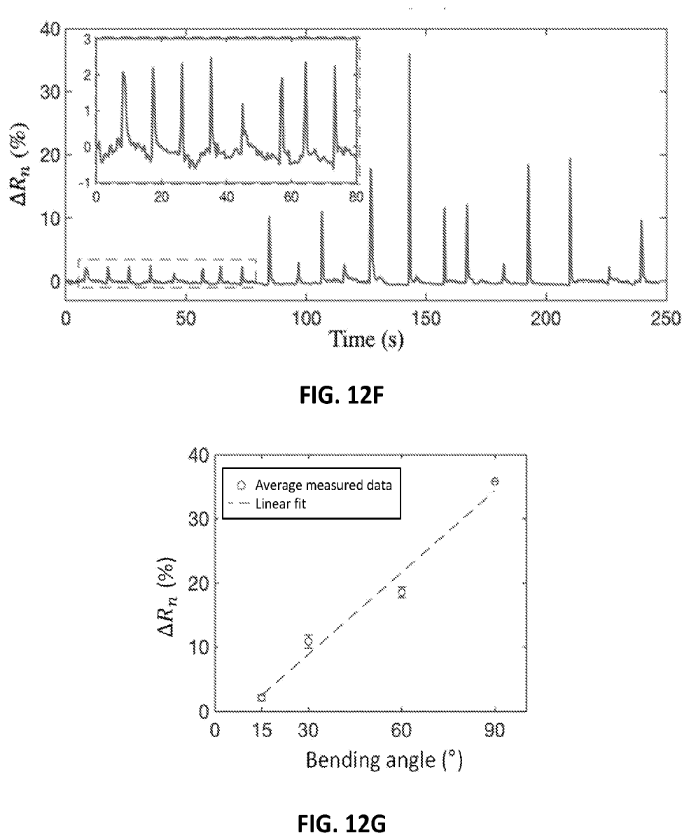

In some embodiments, a flexible sensor 200 can be used to detect strain on more than one axis (e.g., two axes, three axes). In some embodiments, a flexible sensor 200 can be used to detect strain on more than one axis when affixed to a skin 210 of a subject. In FIGS. 12A through 12E, the skin-like flexible sensor 1200 was attached on the index finger along its longitudinal direction for monitoring the finger bending degrees (i.e., 15°, 30°, 60°, and 90°). Since flexible sensor 1200 are highly flexible, they deform with the finger during bending. The response was highly reversible and repeatable, and the sensing performance exhibited an approximate linear relationship with the finger bending angles, which indicated that the flexible sensor 1200 could be used to noninvasively monitor the finger motions.

FIG. 12A depicts a flexible sensor 1200 affixed to a finger 1220 in the longitudinal direction above a knuckle with no bending angle, and therefore approximately no strain was applied to the flexible sensor 1200. FIGS. 12B through 12E depict a finger 1220 of the subject applying strain to the flexible sensor 1200 through bending of the finger 1220. As the finger 1220 undergoes a bending motion, the flexible sensor 1200 affixed to the finger 1220 undergoes strain according to the bending angle of the finer 1220. FIGS. 12B through 12E depict a finger 1220 undergoing bending motions through an angular range of about 0° to about 90° (e.g., 0°, 15°, 30°, 60°, or 90°) .

In some embodiments, the detectable bending angular range that the flexible sensor 1200 can go through can be from about 0° to about 360° (e.g., about 0° to about 90°, about 0° to about 180°, about 0° to about 270°, about 0° to about 360°, about 45° to about 135°, about 45° to about 225°, about 45° to about 315°). In some embodiments, the detectable twist angular can go through can be from about 0° to about 360° (e.g., about 0° to about 90°, about 0° to about 180°, about 0° to about 270°, about 0° to about 360°, about 45° to about 135°, about 45° to about 225°, about 45° to about 315°).

FIG. 12B depicts a finger 1220 undergoing a bending motion through an angular range of about 15°.

FIG. 12C depicts a finger 1220 undergoing a bending motion through an angular range of about 30°.

FIG. 12D depicts a finger 1220 undergoing a bending motion through an angular range of about 60°.

FIG. 12E depicts a finger 1220 undergoing a bending motion through an angular range of about 90°.

FIG. 12F depicts a graph comparing ΔRₙ through time when a cyclic bending strain is applied to the flexible sensor 1200. The x-axis shows a time course in seconds (s) from 0 to 250 s. The y-axis shows the normalized ΔRₙ of the flexible sensor 1200, as detailed above. Higher peak ΔRₙ values correspond to higher bending strain angles as detailed in FIGS. 12A through 12E. Inset to FIG. 12F is a second graph comparing in greater detail ΔRₙ through time of the first 80 s of FIG. 12F. The peak values for ΔRₙ for the inset chart are about 2% ΔR_{n.}

FIG. 12G depicts a graph comparing ΔRₙ with measured bending angle of the finger 1220 on which a flexible sensor 1200 was affixed. The line overlaying the dots is a least-squares linear fit to the data points. ΔRₙ can increase about linearly with bending angle for up to about 90° angles.

In some embodiments, the flexible sensor 200 can be configured to detect pressure. In some embodiments, the flexible sensor 200 can detect pressure in the range of about 1 Pa to about 100 Pa (e.g., about 10 Pa to about 75 Pa, about 25 Pa to about 50 Pa, about 1 Pa to about 50 Pa, about 1 Pa to about 25 Pa, about 1 Pa to about 10 Pa, about 10 Pa to about 30 Pa, or about 10 Pa to about 20 Pa).

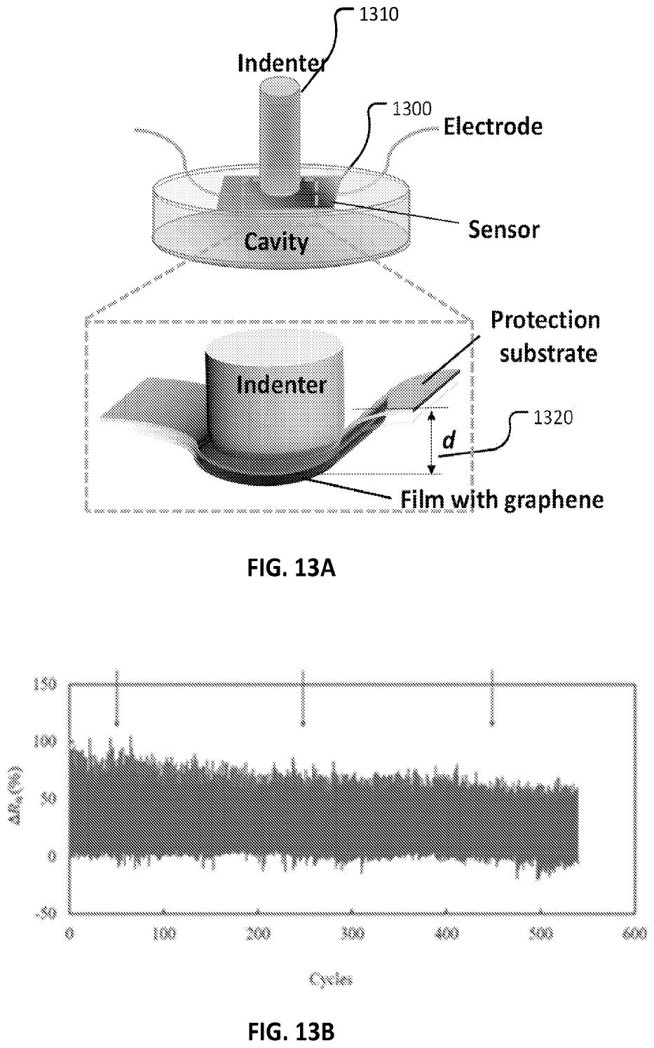

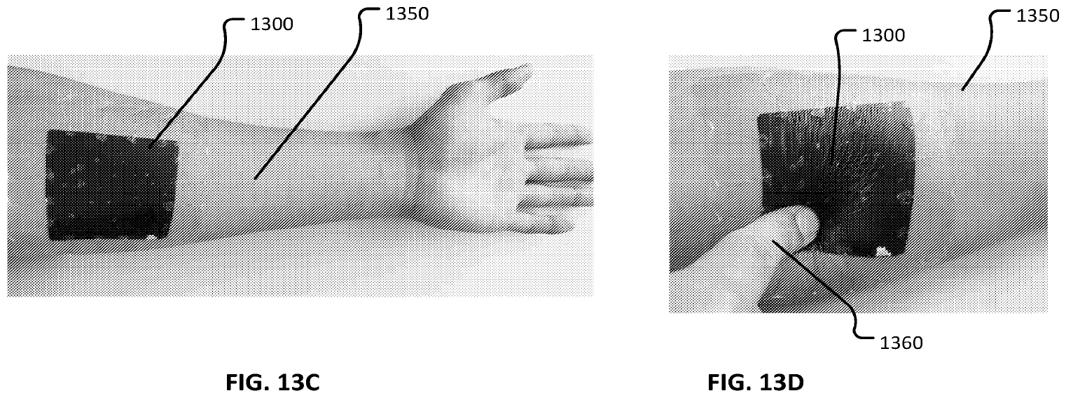

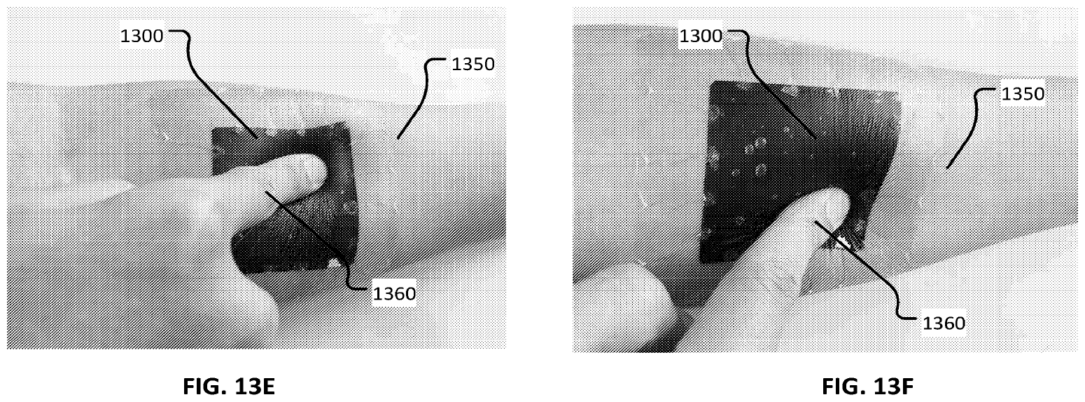

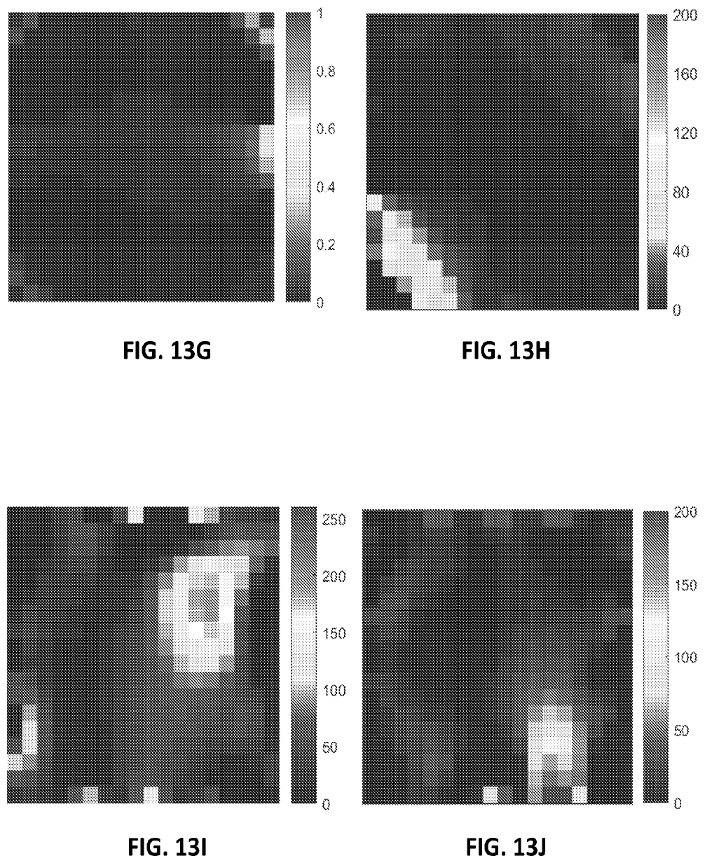

FIG. 13A depicts a system in which a flexible sensor 1300 can be used with a mechanical indenter 1310. The mechanical indenter 1310 can be brought into contact with the flexible sensor 1300. The mechanical indenter 1310 can then be activated to travel in a direction perpendicular to the face of the flexible sensor 1300. As shown inset in FIG. 13A the mechanical indenter 1310 can then travel a distance d 1320 creating a mechanical pressure on the flexible sensor 1300. The electrical resistance of the flexible sensor 1300 can be measured during the mechanical loading process.

FIG. 13B depicts a graph comparing ΔRₙ through time when a cyclic uniaxial mechanical pressure is applied. The x-axis shows a time course in seconds (s) from 0 to 1300 s. The y-axis shows the normalized change in resistance of the flexible sensor 1300, as detailed above. The flexible sensor 1300 is subjected to cyclic perpendicular motion of the mechanical indenter 1310 and the resistivity of the flexible sensor 1300 is measured. The mechanical indenter 1310 was cycled for 500 repetitions from 0 mm to 2 mm displacement at a rate of 0.5 mm/s. After repeated applications of pressure, the flexible sensor 1300 can self-restore to the original dimensions due to the elasticity of the protective layer 170.

In some embodiments, a flexible sensor 1300 can be used to detect mechanical pressure over a spatial area. In some embodiments, a flexible sensor 1300 can be used to detect mechanical pressure over a spatial area when affixed to a skin 1310 of a subject. The flexible sensor 1300 depicted in FIGS. 13C through 13F had boundary electrodes (not shown) affixed to the edges of the flexible sensor 1300. An electrical current was applied to the flexible sensor 1300 and the induced boundary voltages were measured.

In FIGS. 13C through 13F, a 640x 640 mm² flexible sensor 1300 was attached to the skin 1350 of the forearm of a human subject. To achieve spatial pressure mapping capability, a flexible sensor 1300 with four electrodes electrically connected at each boundary was coupled with an electrical impedance tomography (EIT) measurement scheme and algorithm, which allows the determination of the electrical conductivity/resistivity distribution of the flexible sensor 1300.

At an undeformed state, the resistivity distribution of the sensing skin was mostly uniform (FIG. 13G), indicating an approximately homogeneous electrical property achieved by corona printing method. On the other hand, ‘hot spots’ were identified on the reconstructed resistivity maps upon pressure was applied on the sensing domain (FIGS. 13H through 13J). According to the color bars, hotter color refers to larger increase in the electrical resistivity (e.g., higher values on the inset scale bars). Since the flexible sensor 1300 was locally deformed, each reconstructed resistivity map shows a distinct hot spot (i.e., localized increase in resistivity) at the vicinity where the specimen was pressed. It was found that the coupled sensing system could locate the pressure points with relatively high accuracy across the entire area. Therefore, the results indicate the scalable continuous sensing skins could detect and spatially locate the applied contact pressure, which paved the way for their potential applications as large-scale and low-cost artificial smart skins and human-machine interfaces.

FIGS. 13C depicts a flexible sensor 1300 affixed to the skin 1350 of the subject with no applied mechanical pressure. FIGS. 13D through 13F depict a finger 1360 of the subject applying mechanical pressure to an area of the flexible sensor 1300. In FIG. 13D, the finger 1360 of the subject is depicted applying mechanical pressure to the lower left corner of the flexible sensor 1300. In FIG. 13E, the finger 1360 of the subject is depicted applying mechanical pressure to the upper right corner of the flexible sensor 1300. In FIG. 13F, the finger 1360 of the subject is depicted applying mechanical pressure to the lower right corner of the flexible sensor 1300.

FIGS. 13G through 13J depict charts of electrical impedance tomography (EIT). These measurements can be used to determine the spatial electrical resistivity distribution of the flexible sensor 1300 based on measurements obtained from boundary electrodes. FIGS. 13G through 13J further depict the EIT measurements corresponding to the applied mechanical pressure over an area depicted in FIGS. 13C through 13F, respectively. FIGS. 13G through 13J depict a scale reference bar in units of Ω*cm (e.g., bulk resistivity) for their respective charts to the right of the chart. The bulk resistivity measurements have been normalized to a measurement in which no mechanical pressure is applied.

FIG. 13G depicts the EIT measurements corresponding to FIG. 13C in which no mechanical pressure is applied. The scale bar to the right of the chart depicts a normalized measurement scale of about 0 to about 1 Ω*cm.

FIGS. 13H through 13J depict the spatial distribution of the change in bulk resistivity of the flexible sensor 1300 with respect to the FIG. 13G. The x-axes depict the horizontal edge of the sensor with a spatial distance of 4 in and resolution of about 0.2 in. The y-axes depict the vertical edge of the sensor with a spatial distance of 4 in and resolution of about 0.2 in.

FIG. 13H depicts the EIT measurements corresponding to FIG. 13D in which mechanical pressure is applied to a spatial area in the lower left corner of the flexible sensor 1300. The scale bar to the right of the chart depicts a scale of about 0 in blue to about 1300 Ω*cm in red. The largest change in resistivity is shown in the lower left corner of the EIT measurement as a red ‘hot spot’.

FIG. 13I depicts the EIT measurements corresponding to FIG. 13E in which mechanical pressure is applied to a spatial area in the upper right corner of the flexible sensor 1300. The scale bar to the right of the chart depicts a scale of about 0 to about 1350 Ω*cm. The largest change in resistivity is shown in the upper right corner of the EIT measurement as a red ‘hot spot’.

FIG. 13J depicts the EIT measurements corresponding to FIG. 13F in which mechanical pressure is applied to a spatial area in the lower right corner of the flexible sensor 1300. The scale bar to the right of the chart depicts a scale of about 0 to about 1300 Ω*cm. The largest change in resistivity is shown in the lower right corner of the EIT measurement as a red ‘hot spot’.

FIGS. 13G through 13J demonstrate that a normalized change in resistivity in a material sensor 1300 can be correlated to applied mechanical pressure.

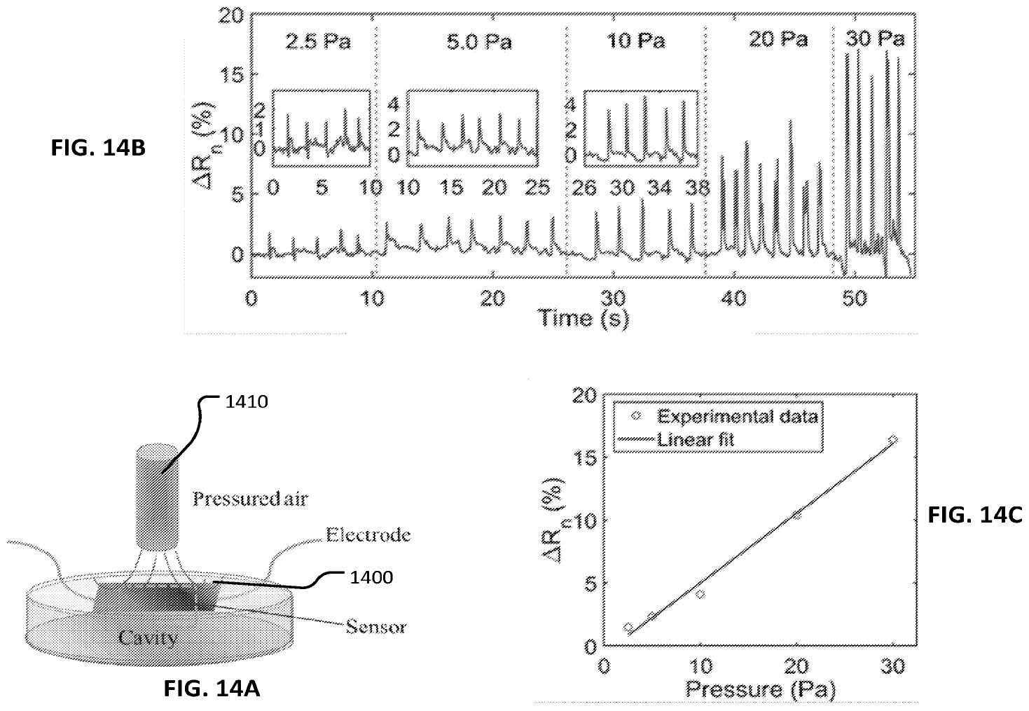

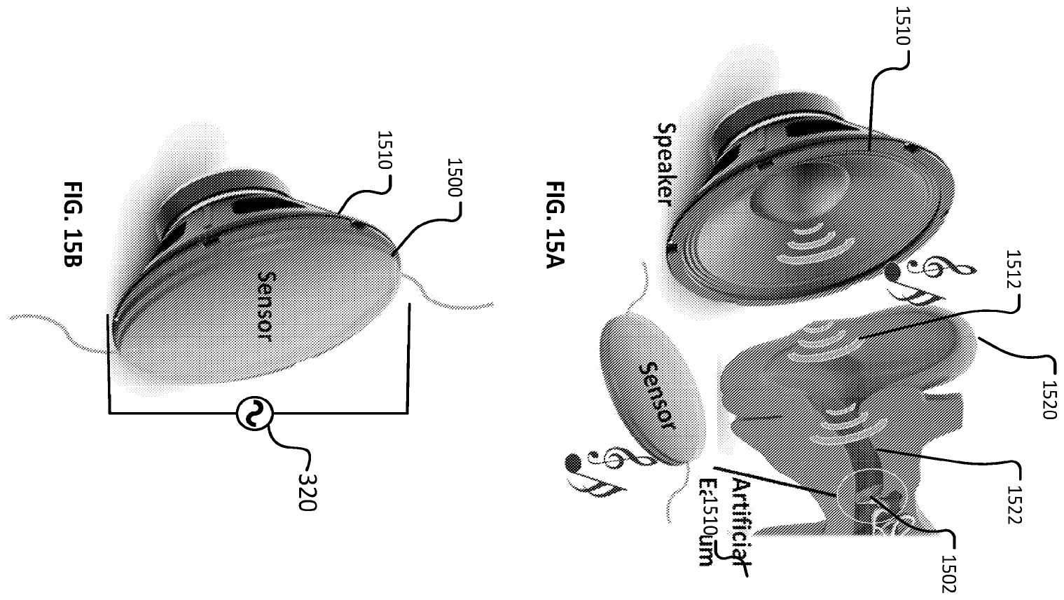

FIG. 14A depicts a system in which a flexible sensor 1400 can be used to detect pressure with a pressurized air nozzle 1410. The pressurized air nozzle 1410 can be brought within a distance of the flexible sensor 1400. The pressurized air nozzle 1410 can then be activated to direct a pressurized flow of air in a direction perpendicular to the face of the flexible sensor 1400. The electrical resistance of the flexible sensor 1400 can be measured during the application of pressurized air process.

FIG. 14B depicts a graph comparing ΔRₙ through time when a cyclic pressurized flow of air is applied to the flexible sensor 1400. The x-axis shows a time course in seconds (s) from 0 to 140 s. The y-axis shows the normalized ΔRₙ of the flexible sensor 1400, as detailed above. The flexible sensor 1400 is subjected to cyclic pressurized flow of air from the pressurized air nozzle 1410 and the resistivity of the flexible sensor 1400 is measured.

The x-axis is further subdivided into several ranges, each range being separated by a vertical dashed line. For example, the x-axis is shown subdivided into a range of 0 to 10 s, 10 to 25 s, 25 to 38 s, 38 to 49 s, and 49 to 60 s. In the first x-axis range from 0 to 10 s, five consecutive pressurized flows of air at a pressure of 2.5 Pa are directed perpendicular to the face of the flexible sensor 1400. In the inset chart within the first x-axis range, each pressurized flow of air is correlated to a peak ranging from 0% to 2% ΔRn.

In the second x-axis range from 10 to 25 s, seven consecutive pressurized flows of air at a pressure of 5.0 Pa are directed perpendicular to the face of the flexible sensor 1400. In the inset chart within the second x-axis range, each pressurized flow of air is correlated to a peak ranging from 0% to 4% ΔR_{n.}

In the third x-axis range from 25 to 38 s, five consecutive pressurized flows of air at a pressure of 10 Pa are directed perpendicular to the face of the flexible sensor 1400. In the inset chart within the third x-axis range, each pressurized flow of air is correlated to a peak ranging from 0% to 4% ΔR_{n.}

In the fourth x-axis range from 38 to 49 s, eight consecutive pressurized flows of air at a pressure of 20 Pa are directed perpendicular to the face of the flexible sensor 1400. Each pressurized flow of air is correlated to a peak ranging from 0% to about 10% ΔR_{n.}

In the fifth x-axis range from 49 to 60 s, five consecutive pressurized flows of air at a pressure of 30 Pa are directed perpendicular to the face of the flexible sensor 1400. Each pressurized flow of air is correlated to a peak ranging from 0% to about 18% ΔR_{n.}

FIG. 14C depicts a chart comparing pressure (Pa) to average peak ΔRₙ for each pressurized air flow pressure from FIG. 14B, e.g. 2.5 Pa, 5.0 Pa, 10 Pa, 20 Pa, 30 Pa. The line overlaying the dots is a linear fit to the data points.

In some embodiments, the flexible sensor 1400 can be used to detect atmospheric pressure changes corresponding to audio signals (e.g., sound waves, or acoustic waves). In some embodiments, a flexible sensor 1400 can be used to detect atmospheric pressure changes corresponding to audio signals within an ear of a user. In some embodiments, the flexible sensor 1400 can be used to differentiate audio signals (e.g., sound waves, or acoustic waves). In some embodiments, the flexible sensor 1400 can be used to generate signal patterns that differentiate different sounds. In some embodiments, the flexible sensor 1400 can be used to generate signal patterns made of different magnitudes and frequencies to differentiate sounds.

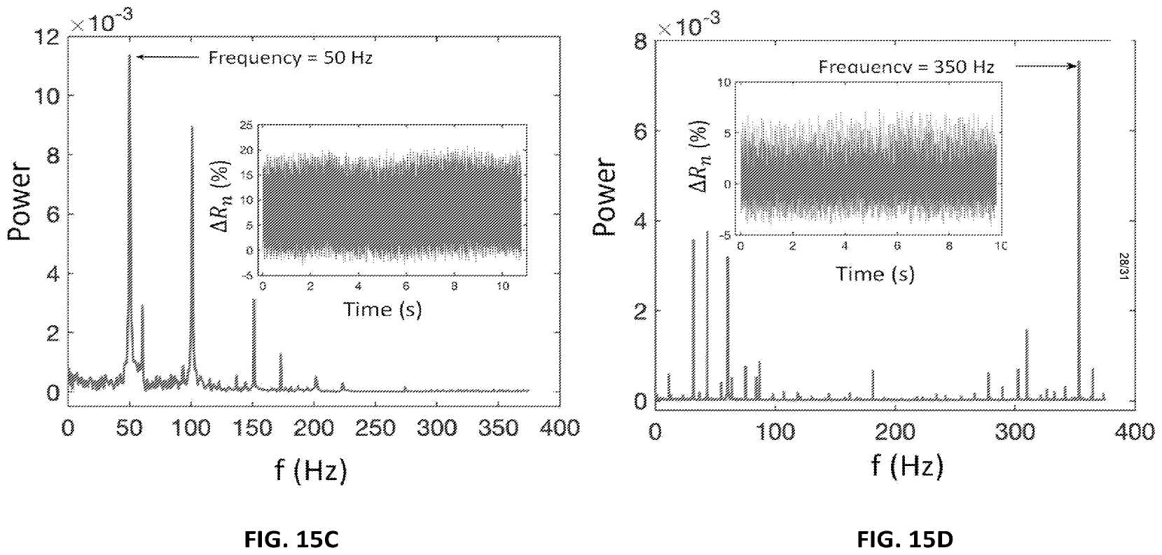

FIG. 15A depicts a speaker 1510 generating an audio signal 1512 (shown as waveforms) directed toward an ear 1520 of a user. The audio signal 1512 can travel down the ear canal 1522 of the ear 1520 of the user towards a flexible embedded sensor 1502 in use as an exemplary ‘artificial eardrum’.

FIG. 15B depicts another embodiment of a flexible sensor 200 used to detect an audio signal 1512 from a speaker 1510. In some embodiments, a flexible sensor 200 used to detect an audio signal 1512 can detect frequencies in a non-limiting range of 1 to 20,000 Hz (e.g., 1 to 100 Hz, 100 to 1000 Hz, 1000 to 10000 Hz, 10000 to 20000 Hz, 1 to 1000 Hz, 1000 to 20000 Hz, 100 to 10000 Hz). The electrical resistivity of the flexible sensor 200 can be measured and recorded using a digital multimeter 320. In some embodiments, the flexible sensor 200 can be configured to differentiate two or more audio signals 1512.

The setup depicted in FIG. 15B can be used to test the frequency response of a flexible sensor 1500. A flexible sensor 1500 can be affixed to the forward face of a speaker 1510 and an audio signal 1512 can be directed to the face of the flexible sensor 1500. In some embodiments, the flexible sensor 1500 can be placed a distance removed from the face of the speaker 1510. For example, the audio signal 1512 can be comprised of different frequencies of sounds (e.g. 50 Hz, 100 Hz, 150 Hz, 200 Hz, 250 Hz, 300 Hz, or 350 Hz).

FIG. 15C depicts a chart of the power spectrum of an audio signal 1512 directed through the face of the flexible sensor 1500. Referring first to the chart inset in FIG. 15C, this chart depicts the time series data compared to the ΔRₙ collected with the digital multimeter 320. The x-axis of the inset chart shows a range of time from 0 to 11 s. The y-axis of the inset chart shows the normalized ΔRₙ(%). FIG. 15C was constructed from the fast Fourier transform (FFT) of the collected data depicted in the inset chart. The x-axis of the FIG. 15C shows the frequency of the spectrum in Hz. The y-axis of FIG. 15C shows the power density in 1×10⁻³ arbitrary units. FIG. 15C depicts the power spectrum of a speaker playing a 50 Hz audio signal 1512. The maximum power density is shown at about 12×10⁻³ arbitrary units at a frequency of 50 Hz. Additional peaks can be seen at 100 Hz, and 150 Hz.

FIG. 15D depicts a second chart displaying the power spectrum of a second exemplary audio signal 1512 directed through the face of a second flexible sensor 1500. Referring first to the chart inset in FIG. 15D, this chart depicts the time series data compared to the ΔRn collected with the digital multimeter 320. The x-axis of the inset chart shows a range of time from 0 to 10 s. The y-axis of the inset chart shows the normalized ΔRₙ (%).

FIG. 15D was constructed from the FFT of the collected data depicted in the inset chart. The x-axis of the FIG. 15D shows the frequency of the spectrum in Hz. The y-axis of FIG. 15D shows the power in 1×10⁻³ arbitrary units. FIG. 15C depicts the power spectrum of a speaker playing a 350 Hz audio signal 1512. The maximum power density is shown at about 8×10⁻³ arbitrary units at a frequency of 350 Hz. Additional peaks can be seen around 50 Hz, and 300 Hz.

FIGS. 15C and 15D demonstrate that a normalized change in resistivity in a material sensor 1500 can be correlated to an audio signal.

In some embodiments, a flexible sensor 200 can be used to detect temperature changes. In some embodiments, a flexible sensor 200 can be used to detect temperature changes in a non-contact method (e.g., optical method, visual method). In some embodiments, a flexible sensor 200 can be used to detect temperature changes in a range of about −20° to about 100° C. (e.g., about −20° to about 100° C., about 0° to about 100° C., about 20° to about 100° C., about 40° to about 100° C., about 60° to about 100° C., about 80° to about 100° C., about −20° to about 80° C., about −20° to about 60° C., about −20° to about 40° C., about −20° to about 20° C., or about −20° to about 0° C.). In some embodiments, a flexible sensor 200 can be used to detect temperature changes with resolution of about 0.1° C. or more (e.g., about 0.1° C. degree or more, about 0.5° C. degree or more, or about 1° C. degree or more).

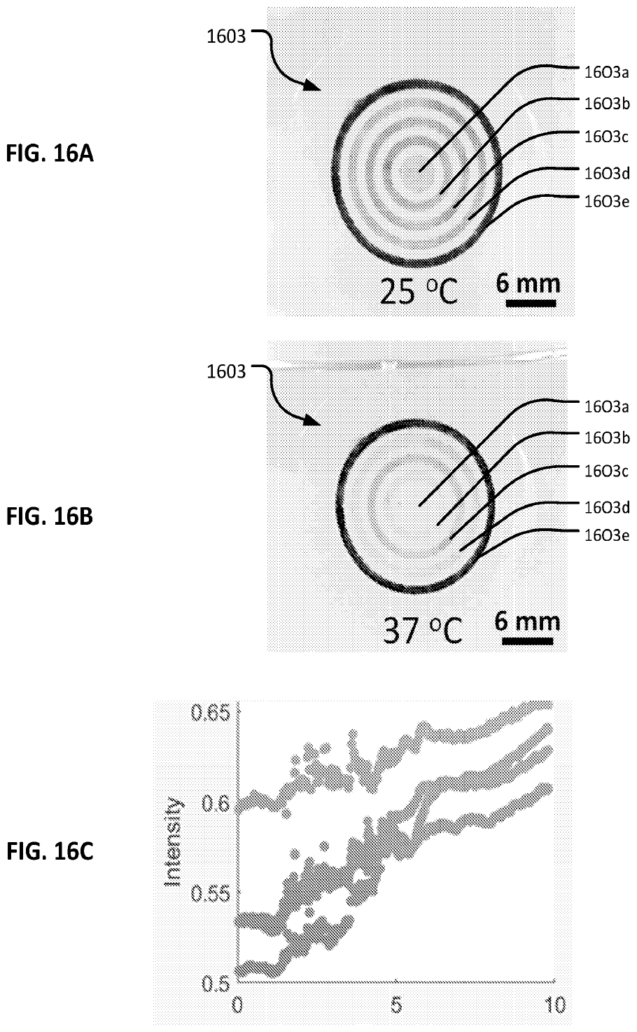

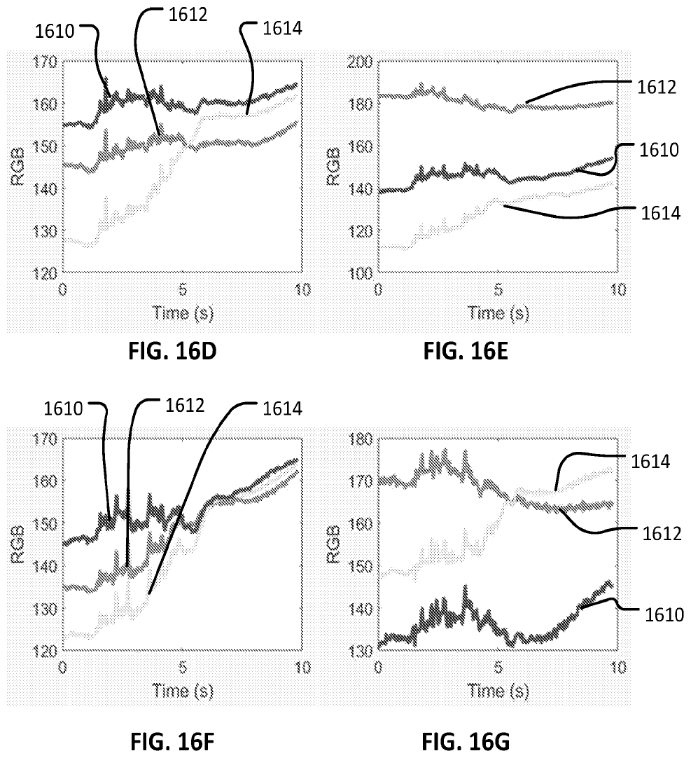

In addition to the strain sensors fabricated with conductive materials, methods disclosed herein can print non-conductive materials. Non-contact corona printing was demonstrated to print thermochromic polymer particles for temperature sensing applications. A mask was inserted between the material and the substrate during printing to create the printed patterns of differing thermochromic powders of FIGS. 16A and 16B. As shown in FIGS. 16A through 16C, printed thermochromic patterns changed their colors within seconds when subjected to temperature change. The color change can be monitored by a camera. And by analyzing the intensity and RGB data of the recorded video, the color change of CEP sensors can be digitalized to allow automatic temperature monitoring as demonstrated in FIGS. 16C and 16G.

FIG. 16A depicts a second exemplary flexible sensor 1603 constructed with five independent features 1603a through 1603e. Feature 1603a is a central circle within four concentric annulus features of increasing inner and outer radius around a central circle of thermochromic powder. In order of increasing average radius, the annulus features 1603b, 1603c, 1603d, and 1603e are concentrically located around central circle feature 1603a. Central circle feature 1603a and annulus features 1603b, 1603c, 1603d, and 1603e are made from a thermochromic powder. Without wishing to be bound by theory, thermochromic powders are a set of materials capable of changing colors under specific temperature conditions.

The flexible sensor 1603 of FIG. 16A has been affixed to the external face of a glass beaker after the interior volume has been filled with room temperature water.

The flexible sensor 1603 of FIG. 16B has been affixed to the external face of a glass beaker after the interior volume has been filled with hot water. FIG. 16C depicts a graph comparing optical intensity through time. The x-axis shows a time course from 0 to 10 s. The y-axis shows an optical intensity measurement in arbitrary units.

FIGS. 16D through 16G depict graphs comparing optical intensity through time. The x-axes shows a time course from 0 to 10 s. The y-axes shows an optical intensity measurement in arbitrary units. The graphs depict three color channels of information in blue 1610, red, 1612, and green 1614. FIGS. 16D through 16G each correspond to different ring as shown in FIG. 16A.

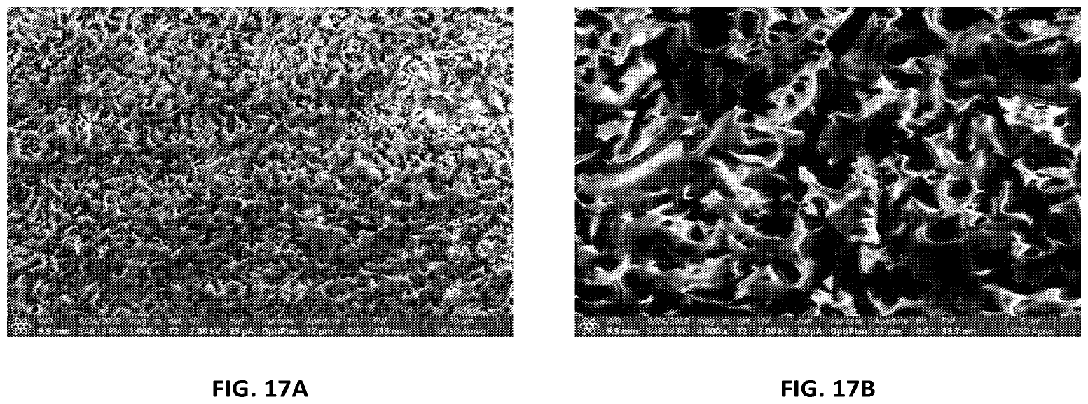

FIG. 17 is an SEM image of a material network 150 on a PET substrate that has been printed with a traditional ink-based printing system. FIGS. 17A and 17B depict bright areas surrounding dark areas. FIG. 17A depicts a binder material network of an area of about 0.03 mm² where the bright areas are binder material and the dark areas are graphene. The graphene area is less than 30% in volume. Over 70% of the volume is non-conductive binder. FIG. 17B depicts a binder material network of an area of about 830 μm² where the bright areas are binder material and the dark areas are graphene. The binder can reduce the movement of the functional material, which influences the sensitivity.

Further referring to FIGS. 17A and 17B, the overall conductivity of the material networks depicted can be reduced because the binders in these material networks are not necessarily conductive.

### OTHER EMBODIMENTS

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method of printing, comprising:
disposing a substrate between a discharge electrode and a printing material, the substrate being spaced apart from the printing material; and
activating the discharge electrode to generate an electric field between the substrate and the printing material, wherein the printing material moves onto a surface of the substrate when the electric field attracts the printing material to the surface of the substrate.

2. The method of claim 1, wherein the generating the electric field comprises applying a corona treatment to the substrate.

3. The method of claim 1, wherein the generating the electric field comprises applying a voltage of about 5 kV to about 100 kV to the discharge electrode.

4. The method of claim 1, wherein the substrate comprises a film, textile, a 3D printed object, an injection molded object, an assembled object, or a welded object.

5. The method of claim 1, wherein the substrate comprises one or more polymers selected from the group consisting of polyurethane, a nylon, polyester, polystyrene, polyethylene terephthalate (PET), polymethyl methacrylate (PMMA), polyethylene (PE), polystyrene (PS), and silicone.

6. The method of claim 1, wherein the substrate comprises a dielectric material, or a dielectric-coated material.

7. The method of claim 1, wherein the printing material comprises wires, tubes, particles, powders, or combinations thereof.

8. The method of claim 1, wherein the printing material comprises particles having a mean particle size that is selected from a group consisting of less than 2 mm, less than 500 μm, less than 300 μm, and less than 50 μm.

9. A system for non-contact printing, the system comprising:
a substrate,
a discharge electrode coupled to a power source, the discharge electrode configured to apply an electrical discharge to the substrate located in a zone;
a source comprising a printing material, the source positioned adjacent to the substrate; and
a conveyer configured for transporting the substrate;
wherein, when the substrate is placed in the zone, the system is configured to generate an electric field between the substrate and the printing material such that the printing material moves from the source to a portion of the substrate to from a printed substrate; and
wherein the system continuously transports the printed substrate away from the zone while placing a new substrate in the zone.

10. The system of claim 9, wherein the substrate is in a form of sheets or a roll.

11. The system of claim 9, wherein the conveyer comprises one or more rollers for transporting the substrate.

12. The system of claim 9, wherein the discharge electrode comprises multiple discharge electrodes.

13. The system of claim 9, wherein the source is configured to provide a renewed supply of printing material.

14. A sensor, comprising:
a substrate;
one or more electrodes electrically coupled to the substrate; and
a plurality of particles disposed on a surface of the substrate, wherein the sensor is substantially free of a binder.

15. The sensor claim 14, wherein the substrate contains one of less than 1 wt. % of a binder, less than 0.5 wt. % of a binder, less than 0.1 wt. % of a binder, or less than 0.01 wt. % of a binder.

16. The sensor of claim 15, wherein the particles are selected from a group consisting of graphene, carbon nanotube, metallic nanoparticles, metallic microparticles, carbon nanoparticles, carbon microparticles, nanorods, nanowires, microrods, microwires, metallic microsheets, metallic nanosheets, carbon nanosheets, carbon microsheets, poly(3,4-ethylenediox-ythiophene):polystyrene sulfonate particles, indium tin oxide particles, polymer particles, ceramic particles, or combinations thereof.

17. The sensor of claim 14, wherein the sensor is configured to monitor one or more physiological parameters selected from the group consisting of skin conductivity, glucose, respiration, oculogyration, oxygen saturation, temperature, heart rate, pulsation, electrical activity, pH, chemical presence, neurological activity, eye blinking, facial expressions, vocal vibrations, mouth movements, swallowing, elbow movements, arm movement, hand pressure, or foot pressure.

18. The sensor of claim 14, wherein the sensor is configured to detect a pressure applied on the substrate.

19. The sensor of claim 14, wherein the sensor is configured to detect, or differentiate acoustic waves.

20. The sensor of claim 14, wherein a protective layer is disposed on the surface of the substrate, wherein the protective layer comprises polyurethane, a nylon, polyester, polystyrene, polyethylene terephthalate (PET), polymethyl methacrylate (PMMA), polyethylene (PE), polystyrene (PS), and silicone.
